(19) United States
(12) Patent Application Publication
(10) Pub. No.: US 2012/0094223 A1
(43) Pub. Date: Apr. 19, 2012

(54) IMAGE FORMING APPARATUS AND PROCESS CARTRIDGE

(75) Inventors: Fuyuki KANO, Kanagawa (JP); Shigeto HASHIBA, Kanagawa (JP); Kazuhiro KOSEKI, Kanagawa (JP); Shinya YAMAMOTO, Kanagawa (JP); Satoya SUGIURA, Kanagawa (JP); Kenta IDE, Kanagawa (JP); Kosuke NARITA, Kanagawa (JP)

(73) Assignee: FUJI XEROX CO., LTD., TOKYO (JP)

(21) Appl. No.: 13/113,624

(22) Filed: May 23, 2011

(30) Foreign Application Priority Data
Oct. 15, 2010 (JP) 2010-232875

(51) Int. Cl. G03G 15/00; G03G 21/18

(52) U.S. Cl. 430/56; 399/111; 399/159

(57) ABSTRACT

An image forming apparatus includes an electrophotographic photoconductor that includes an outermost surface layer containing a binder resin having a structural unit represented by general formula (A) below and a charge transporting material having a butadiene trimer structure in a single molecule, a charging unit that charges the electrophotographic photoconductor, an electrostatic latent image forming unit that forms an electrostatic latent image, a toner image forming unit that forms a toner image, and a transfer unit that transfers the toner image formed on the electrophotographic photoconductor onto a transfer-receiving body,

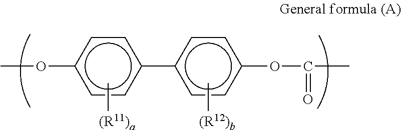

where R¹¹ and R¹² each independently represent a halogen atom, an alkyl group having 1 to 6 carbon atoms, a cycloalkyl group having 5 to 7 carbon atoms, or an aryl group having 6 to 12 carbon atoms; and a and b each independently represent an integer of 0 to 4.

### CROSS-REFERENCE TO RELATED APPLICATIONS

This application is based on and claims priority under 35 USC 119 from Japanese Patent Application No. 2010-232875 filed Oct. 15, 2010.

### BACKGROUND

(i) Technical Field

The present invention relates to an image forming apparatus and a process cartridge.

(ii) Related Art

In conventional electrophotographic image forming apparatuses, a toner image formed on the surface of an electrophotographic photoconductor is transferred onto a medium to be recorded through the processes of charging, exposure, development, and transfer.

### SUMMARY

According to an aspect of the invention, there is provided an image forming apparatus including:

an electrophotographic photoconductor that includes an outermost surface layer containing a binder resin having a structural unit represented by general formula (A) below and a charge transporting material having a butadiene trimer structure in a single molecule;

a charging unit that charges the electrophotographic photoconductor and includes an outermost surface layer containing a porous filler and having a surface roughness Rz of about 2 μm or more and about 20 μm or less;

an electrostatic latent image forming unit that forms an electrostatic latent image by exposing the charged electrophotographic photoconductor;

a toner image forming unit that forms a toner image by developing, with a developer containing a toner, the electrostatic latent image formed on the electrophotographic photoconductor; and

a transfer unit that transfers the toner image formed on the electrophotographic photoconductor onto a transfer-receiving body.

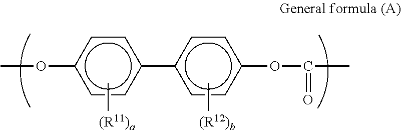

In the general formula (A), R¹¹ and R¹² each independently represent a halogen atom, an alkyl group having 1 to 6 carbon atoms, a cycloalkyl group having 5 to 7 carbon atoms, or an aryl group having 6 to 12 carbon atoms; and a and b each independently represent an integer of 0 to 4.

### BRIEF DESCRIPTION OF THE DRAWINGS

Exemplary embodiments of the present invention will be described in detail based on the following figures, wherein:

FIG. 1 schematically shows an image forming apparatus according to this exemplary embodiment;

FIG. 2 schematically shows an image forming apparatus according to another exemplary embodiment;

FIG. 3 is a sectional view schematically showing an electrophotographic photoconductor according to this exemplary embodiment;

FIG. 4 is a sectional view schematically showing an electrophotographic photoconductor according to another exemplary embodiment; and

FIG. 5 is a sectional view schematically showing a charging device according to this exemplary embodiment.

### DETAILED DESCRIPTION

An embodiment, which is an example of the present invention, will now be described.

An image forming apparatus according to this exemplary embodiment includes an electrophotographic photoconductor, a charging unit that charges the electrophotographic photoconductor, an electrostatic latent image forming unit that forms an electrostatic latent image by exposing the charged electrophotographic photoconductor, a toner image forming unit that forms a toner image by developing, with a developer containing a toner, the electrostatic latent image formed on the electrophotographic photoconductor, and a transfer unit that transfers the toner image formed on the electrophotographic photoconductor onto a transfer-receiving body.

The electrophotographic photoconductor includes an outermost surface layer that contains a binder resin having a structural unit represented by general formula (A) and a charge transporting material having a butadiene trimer structure in a single molecule. The charging unit includes an outermost surface layer that contains a porous filler and has a surface roughness Rz of 2 μm or more and 20 μm or less or about 2 μm or more and about 20 μm or less.

In the image forming apparatus according to this exemplary embodiment, the above-described structure suppresses the formation of streaked image defects that are formed on a band-shaped image in the circumferential direction of the electrophotographic photoconductor when the band-shaped image is repeatedly formed.

This reason is unclear, but is assumed to be as follows.

When a binder resin having a structural unit represented by the general formula (A) is applied to the outermost surface layer of the electrophotographic photoconductor, the mechanical strength of the outermost surface layer is increased. When a charge transporting material having a butadiene trimer structure in a single molecule is applied to the outermost surface layer, the charge mobility is increased and the electrical characteristics such as a rest potential of the outermost surface layer are improved.

In the electrophotographic photoconductor having such an outermost surface layer, depositions (e.g., discharge products and toners (toner particles and external additives)) do not readily adhere to the surface. However, such depositions are readily transferred onto the surface of the charging unit, which tends to increase the surface contamination of the charging unit. As a result, it is believed that, when a band-shaped image is repeatedly formed, streaked image defects readily form on the band-shaped image in the circumferential direction of the electrophotographic photoconductor.

Herein, by adjusting the surface roughness Rz of the outermost surface layer of the charging unit to be 2 μm or more and 20 μm or less or about 2 μm or more and about 20 μm or less, the surface contamination of the charging unit tends to be suppressed. To adjust the surface roughness Rz of the outermost surface layer within the above-described range, it is believed to be effective to add a filler to the outermost surface layer.

However, it has been found that, when a non-porous filler is added to the outermost surface layer of the charging unit to adjust the surface roughness Rz, the discharge amount is decreased due to the discharge load during charging and thus charging failure is likely to occur.

On the other hand, when a porous filler is added to the outermost surface layer of the charging unit to adjust the surface roughness Rz, a decrease in discharge amount caused by the discharge load during charging is suppressed probably because of the spaces inside the porous filler.

Accordingly, in the image forming apparatus of this exemplary embodiment, it is supposed that the contamination of the charging unit caused by depositions (e.g., discharge products and toners (toner particles and external additives)) is suppressed while a decrease in discharge amount caused by the discharge load during charging is suppressed. Thus, even when a band-shaped image is repeatedly formed, streaked image defects do not readily form on the band-shaped image in the circumferential direction of the electrophotographic photoconductor.

The contamination of the charging unit caused by depositions (e.g., discharge products and toners (toner particles and external additives)) and a decrease in discharge amount caused by the discharge load during charging are likely to occur, for example, when a charging potential is increased to achieve high gradation. However, the combination of the electrophotographic photoconductor and the charging unit each having the above-described outermost surface layer is believed to suppress the formation of streaked image defects even if charging is performed using a wide range of charging potentials.

In the charging unit having the above-described outermost surface layer, the uniform chargeability and the contamination resistance are improved, and thus the durability of a charging member is improved, which provides long-term chargeability. In particular, in the outermost surface layer containing a porous filler, the damage to the surface caused by fatigue as a result of long-term use is suppressed and cracking of the outermost surface layer is suppressed. If toners or external additives of the toners are attached to or deposited in cracked portions, the surface resistance of a charging member varies and thus the charging performance becomes unstable, resulting in image defects. However, by suppressing cracking of the outermost surface layer, the formation of image defects is suppressed. Accordingly, the uniform chargeability of the charging unit is improved and thus the durability of a charging member is improved, which achieves excellent long-term chargeability of the charging unit.

This exemplary embodiment will now be described with reference to the attached drawings.

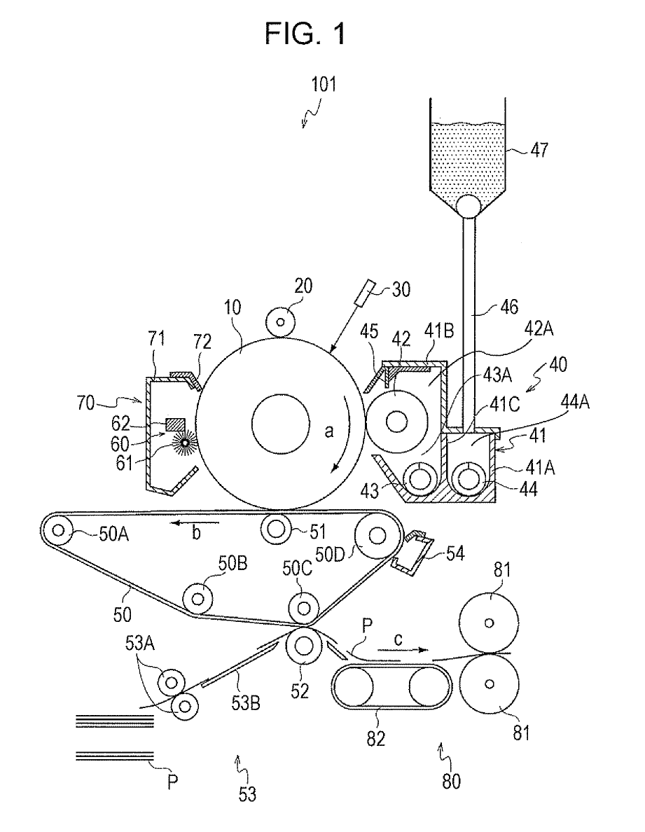

FIG. 1 schematically shows an image forming apparatus according to this exemplary embodiment.

As shown in FIG. 1, an image forming apparatus 101 according to this exemplary embodiment includes, for example, an electrophotographic photoconductor 10 that rotates in a clockwise direction as indicated by an arrow a, a charging device 20 (an example of a charging unit) that charges the surface of the electrophotographic photoconductor 10 and is disposed above the electrophotographic photoconductor 10 so as to face the electrophotographic photoconductor 10, an exposing device 30 (an example of an electrostatic latent image forming unit) that forms an electrostatic latent image by exposing the surface of the electrophotographic photoconductor 10 charged by the charging device 20, a developing device 40 (an example of a developing unit) that forms a toner image on the surface of the electrophotographic photoconductor 10 by attaching a toner contained in a developer to the electrostatic latent image formed by the exposing device 30, a belt-shaped intermediate transfer body 50 that moves in a direction indicated by an arrow b while being in contact with the electrophotographic photoconductor 10 and transfers the toner image formed on the surface of the electrophotographic photoconductor 10, and a cleaning device 70 (an example of a cleaning unit) that cleans the surface of the electrophotographic photoconductor 10.

The charging device 20, the exposing device 30, the developing device 40, the intermediate transfer body 50, a lubricant supplying device 60, and the cleaning device 70 are disposed near/on the circumference of the electrophotographic photoconductor 10 in a clockwise direction. In this exemplary embodiment, the lubricant supplying device 60 is disposed inside the cleaning device 70. However, the lubricant supplying device 60 may be disposed separately from the cleaning device 70.

The intermediate transfer body 50 is held by supporting rollers 50A and 50B, a rear roller 50C, and a driving roller SOD, which provide tension to the intermediate transfer body 50 from the inside. The intermediate transfer body 50 is driven along with the rotation of the driving roller 50D in a direction indicated by the arrow b. A first transfer device 51 is disposed at a position inside the intermediate transfer body 50 so as to face the electrophotographic photoconductor 10. The first transfer device 51 charges the intermediate transfer body 50 in a polarity opposite to the charge polarity of the toner to allow the toner on the electrophotographic photoconductor 10 to move onto the outer surface of the intermediate transfer body 50. A second transfer device 52 is disposed below the intermediate transfer body 50 so as to face the rear roller 50C. The second transfer device 52 charges recording paper P (an example of a recording medium) in a polarity opposite to the charge polarity of the toner to transfer the toner image formed on the intermediate transfer body 50 onto the recording paper P. These members for transferring the toner image formed on the electrophotographic photoconductor 10 onto the recording paper P correspond to an example of a transfer unit.

Furthermore, a recording paper supplying device 53 and a fixing device 80 are disposed below the intermediate transfer body 50. The recording paper supplying device 53 supplies the recording paper P to the second transfer device 52. The fixing device 80 transports the recording paper P on which the toner image has been formed by the second transfer device 52 and fixes the toner image.

The recording paper supplying device 53 includes a pair of transporting rollers 53A and a guide plate 53B that guides the recording paper P transported by the transporting rollers 53A toward the second transfer device 52. The fixing device 80 includes fixing rollers 81 that are a pair of heat rollers configured to fix the toner image by applying heat and pressure to the recording paper P on which the toner image has been transferred by the second transfer device 52, and a transport rotation body 82 that transports the recording paper P toward the fixing rollers 81.

The recording paper P is transported in a direction indicated by an arrow c by the recording paper supplying device 53, the second transfer device 52, and the fixing device 80.

Furthermore, an intermediate-transfer-body cleaning device 54 having a cleaning blade for removing the toner left on the intermediate transfer body 50 after the toner image has been transferred onto the recording paper P by the second transfer device 52 is disposed on the intermediate transfer body 50.

The constitutional members of the image forming apparatus 101 according to this exemplary embodiment will now be described in details.

### (Electrophotographic Photoconductor)

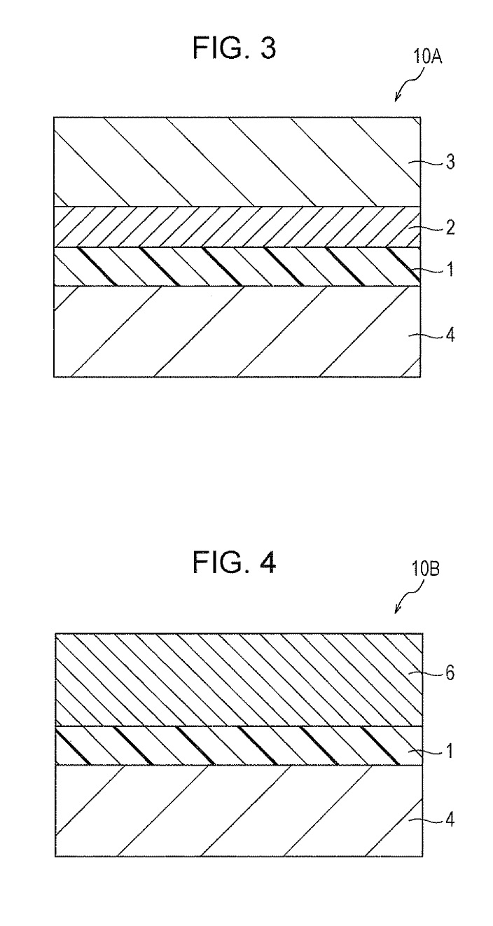

FIG. 3 is a sectional view schematically showing an electrophotographic photoconductor according to this exemplary embodiment. FIG. 4 is a sectional view schematically showing an electrophotographic photoconductor according to another exemplary embodiment.

An electrophotographic photoconductor 10A shown in FIG. 3 is, for example, a so-called function-separated photoconductor (or multi-layered photoconductor) and has a structure obtained by forming an undercoating layer 1 on a conductive substrate 4 and then by forming a charge generating layer 2 and a charge transporting layer 3 thereon in sequence. In the electrophotographic photoconductor 10A, the charge generating layer 2 and the charge transporting layer 3 constitute a photosensitive layer.

In the electrophotographic photoconductor 10A shown in FIG. 3, the charge transporting layer 3 is an outermost surface layer disposed farthest from the conductive substrate 4.

An electrophotographic photoconductor 10B shown in FIG. 4 contains a charge generating material and a charge transporting material in a single layer (single-layer type photosensitive layer 6 (charge generating/transporting layer)).

Specifically, the electrophotographic photoconductor 10B shown in FIG. 4 has a structure in which an undercoating layer 1 is formed on a conductive substrate 4 and a single-layer type photosensitive layer 6 is formed thereon.

In the electrophotographic photoconductor 10B shown in FIG. 4, the single-layer type photosensitive layer 6 is an outermost surface layer disposed farthest from the conductive substrate 4.

In the electrophotographic photoconductors shown in FIGS. 3 and 4, the undercoating layer 1 is not necessarily formed.

Each of the components of the electrophotographic photoconductor 10 will now be described. Note that the reference numerals are omitted.

First, a conductive substrate is described. The term “conductive substrate” means that, for example, the substrate has a volume resistivity of 10¹³ Ω·cm or less.

Any conventional conductive substrate may be used. Examples of the conductive substrate include plastic films having a thin film (e.g., a metal such as aluminum, nickel, chromium, stainless steel, or the like or a film of aluminum, titanium, nickel, chromium, stainless steel, gold, vanadium, tin oxide, indium oxide, indium tin oxide (ITO), or the like), paper to which a conductivity-imparting agent is applied and paper impregnated with a conductivity-imparting agent, and plastic films to which a conductivity-imparting agent is applied and plastic films impregnated with a conductivity-imparting agent. The shape of the conductive substrate is not limited to a cylindrical shape, and a sheet shape or a plate shape may be employed.

When a metal pipe is used as the conductive substrate, the surface of the metal pipe may remain unprocessed or may be subjected to mirror cutting, etching, anodic oxidation, rough cutting, centerless grinding, sandblasting, wet honing, or the like in advance.

Next, an undercoating layer is described.

The undercoating layer is optionally formed in order to prevent light reflection on the surface of the conductive substrate and prevent undesired carriers from flowing into the photosensitive layer from the conductive substrate.

The undercoating layer contains, for example, a binder resin and optionally other additives.

Examples of the binder resin contained in the undercoating layer include publicly known polymer compounds such as acetal resin, e.g., polyvinyl butyral, polyvinyl alcohol resin, casein, polyamide resin, cellulose resin, gelatin, polyurethane resin, polyester resin, methacrylic resin, acrylic resin, polyvinyl chloride resin, polyvinyl acetate resin, vinyl chloride-vinyl acetate-maleic anhydride resin, silicone resin, silicone-alkyd resin, phenol resin, phenol-formaldehyde resin, melamine resin, and urethane resin; charge transporting resins having a charge transporting group; and conductive resins such as polyaniline. Among these, resins insoluble in a coating solvent for an upper layer are preferred, and phenol resin, phenol-formaldehyde resin, melamine resin, urethane resin, epoxy resin, and the like are particularly preferred.

The undercoating layer may contain a metal compound such as a silicon compound, an organic zirconium compound, an organic titanium compound, or an organic aluminum compound.

The ratio of the metal compound to the binder resin is not particularly limited, and any ratio may be set as long as desired characteristics of electrophotographic photoconductors are achieved.

Resin particles may be added to the undercoating layer to adjust the surface roughness. Examples of the resin particles include silicone resin particles and crosslinked polymethyl methacrylate (PMMA) resin particles. To adjust the surface roughness, after the undercoating layer is formed, the surface of the undercoating layer may be polished. Examples of the polishing method include buff polishing, sand blasting, wet horning, and grinding.

The undercoating layer contains, for example, at least the binder resin and conductive particles. Herein, the term “conductive particles” means that, for example, the particles have a volume resistivity of less than 10⁷ Ω·cm.

Examples of the conductive particles include metal particles (particles of aluminum, copper, nickel, silver, or the like), conductive metal oxide particles (particles of antimony oxide, indium oxide, tin oxide, zinc oxide, or the like), and conductive substance particles (particles of carbon fiber, carbon black, or graphite powder). Among these conductive particles, conductive metal oxide particles are suitably used. The conductive particles may be used in combination.

The conductive particles may be subjected to surface treatment with a hydrophobizing agent (e.g., coupling agent) to adjust the resistance.

The content of the conductive particles is, for example, preferably 10% or more and 80% or less by mass and more preferably 40% or more and 80% or less by mass relative to the binder resin.

In the formation of the undercoating layer, a coating solution for forming the undercoating layer obtained by adding the above-described components to a solvent is used. Particles are dispersed in the coating solution for forming the undercoating layer using a media dispersing machine such as a ball mill, a vibrating ball mill, an attritor, a sand mill, or a horizontal sand mill or a medialess dispersing machine such as a stirrer, an ultrasonic dispersing machine, a roll mill, or a high-pressure homogenizer. Herein, high-pressure homogenizers include a collision-type homogenizer that disperses a dispersion through liquid-liquid collision or liquid-wall collision under high pressure and a penetration-type homogenizer that disperses a dispersion by forcing the dispersion through a fine channel under high pressure.

The coating solution for forming the undercoating layer is applied on the conductive substrate by dip coating, ring coating, wire bar coating, spray coating, blade coating, knife coating, curtain coating, or the like.

The thickness of the undercoating layer is preferably 15 μm or more and more preferably 20 μm or more and 50 μm or less.

An intermediate layer (not shown) may be further formed between the undercoating layer and the photosensitive layer. Examples of the binder resin used for the intermediate layer include polymer compounds such as acetal resin, e.g., polyvinyl butyral, polyvinyl alcohol resin, casein, polyamide resin, cellulose resin, gelatin, polyurethane resin, polyester resin, methacrylic resin, acrylic resin, polyvinyl chloride resin, polyvinyl acetate resin, vinyl chloride-vinyl acetate-maleic anhydride resin, silicone resin, silicone-alkyd resin, phenol-formaldehyde resin, and melamine resin; and organic metal compounds containing zirconium, titanium, aluminum, manganese, or silicon. These compounds may be used alone or as a mixture or a polycondensate of two or more. Among these compounds, an organic metal compound containing zirconium or silicon is suitably used.

In the formation of the intermediate layer, a coating solution for forming the intermediate layer obtained by adding the above-described components to a solvent is used.

The coating solution for forming the intermediate layer is applied by a typical method such as dip coating, ring coating, wire bar coating, spray coating, blade coating, knife coating, or curtain coating.

The thickness of the intermediate layer is suitably set to be, for example, 0.1 μm or more and 3 μm or less. This intermediate layer may be used as the undercoating layer.

Next, a charge generating layer is described.

The charge generating layer contains, for example, a charge generating material and a binder resin. Examples of the charge generating material include phthalocyanine pigments such as metal-free phthalocyanine, chlorogallium phthalocyanine, hydroxygallium phthalocyanine, dichlorotin phthalocyanine, and titanyl phthalocyanine. In particular, there are exemplified a chlorogallium phthalocyanine crystal having strong diffraction peaks at least at Bragg angles (2θ±0.2°) of 7.4°, 16.6°, 25.5°, and 28.3° in the X-ray diffraction spectrum measured using a CuKα characteristic X-ray, a metal-free phthalocyanine crystal having strong diffraction peaks at least at Bragg angles (2θ±0.2°) of 7.7°, 9.3°, 16.9°, 17.5°, 22.4°, and 28.8° in the X-ray diffraction spectrum measured using a CuKα characteristic X-ray, a hydroxygallium phthalocyanine crystal having strong diffraction peaks at least at Bragg angles (2θ±0.2°) of 7.5°, 9,9°, 12.5°, 16.3°, 18.6°, 25.1°, and 28.3° in the X-ray diffraction spectrum measured using a CuKα characteristic X-ray, and a titanyl phthalocyanine crystal having strong diffraction peaks at least at Bragg angles (2θ±0.2°) of 9.6°, 24.1°, and 27.2° in the X-ray diffraction spectrum measured using a Cukα characteristic X-ray. Other examples of the charge generating material include quinone pigments, perylene pigments, indigo pigments, bisbenzimidazole pigments, anthrone pigments, and quinacridone pigments. These charge generating materials may be used alone or in combination.

Examples of the binder resin constituting the charge generating layer include bisphenol A or bisphenol Z polycarbonate resin, acrylic resin, methacrylic resin, polyarylate resin, polyester resin, polyvinyl chloride resin, polystyrene resin, acrylonitrile-styrene copolymer resin, acrylonitrile-butadiene copolymer resin, polyvinyl acetate resin, polyvinyl formal resin, polysulfone resin, styrene-butadiene copolymer resin, vinylidene chloride-acrylonitrile copolymer resin, vinyl chloride-vinyl acetate-maleic anhydride resin, silicone resin, phenol-formaldehyde resin, polyacrylamide resin, polyamide resin, and poly-N-vinylcarbazole resin. These binder resins may be used alone or in combination.

The compounding ratio of the charge generating material to the binder resin is suitably 10:1 to 1:10.

In the formation of the charge generating layer, a coating solution for forming the charge generating layer obtained by adding the above-described components to a solvent is used.

Particles (e.g., charge generating material) are dispersed in the coating solution for forming the charge generating layer using a media dispersing machine such as a ball mill, a vibrating ball mill, an attritor, a sand mill, or a horizontal sand mill or a medialess dispersing machine such as a stirrer, an ultrasonic dispersing machine, a roll mill, or a high-pressure homogenizer. High-pressure homogenizers include a collision-type homogenizer that disperses a dispersion through liquid-liquid collision or liquid-wall collision under high pressure and a penetration-type homogenizer that disperses a dispersion by forcing the dispersion through a fine channel under high pressure.

The coating solution for forming the charge generating layer is applied on the undercoating layer by dip coating, ring coating, wire bar coating, spray coating, blade coating, knife coating, curtain coating, or the like.

The thickness of the charge generating layer is preferably 0.01 μm or more and 5 μm or less and more preferably 0.05 μm or more and 2.0 μm or less.

Next, a charge transporting layer is described.

The charge transporting layer contains, for example, a binder resin having a structural unit represented by the general formula (A) and a charge transporting material having a butadiene trimer structure in a single molecule.

The charge transporting material is described. The charge transporting material is a compound having a butadiene trimer structure in a single molecule.

A specific example of the charge transporting material having a butadiene trimer structure in a single molecule is a charge transporting material represented by the following general formula (1).

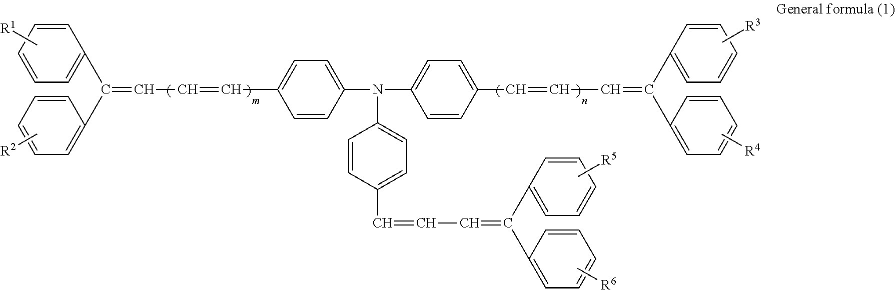

In the general formula (1), R¹, R², R³, R⁴, R⁵, and R⁶ each independently represent a hydrogen atom, a halogen atom, an alkyl group having 1 to 20 carbon atoms, an alkoxy group having 1 to 20 carbon atoms, or a substituted or unsubstituted aryl group having 6 to 30 carbon atoms; the two adjacent substituents may be bonded to each other to form a hydrocarbon ring structure; and n and m each independently represent 1 or 2.

Examples of the halogen atom represented by R¹, R², R³, R⁴ R⁵, and R⁶ in the general formula (1) include fluorine, chlorine, bromine, and iodine. Among these, fluorine and chlorine are desired.

Examples of the alkyl group represented by R¹, R², R³, R⁴, R⁵, and R⁶ in the general formula (1) include linear groups such as a methyl group, an ethyl group, a propyl group, a butyl group, an octyl group, an octadecyl group and branched groups such as an isopropyl group and a t-butyl group. Among these, groups having a relatively low molecular weight, such as a methyl group, an ethyl group, and an isopropyl group, are desired.

Examples of the alkoxy group represented by R¹, R², R³, R⁴, R⁵, and R⁶ in the general formula (1) include a methoxy group and an ethoxy group. Among these, a methoxy group is desired.

Examples of the aryl group represented by R¹, R², R³, R⁴, R⁵, and R⁶ in the general formula (1) include a phenyl group, a naphthyl group, a phenanthryl group, and a biphenyl group. Among these, a phenyl group and a naphthyl group are desired.

The substituents represented by R¹, R², R³, R⁴, R⁵, and R⁶ may further have a substituent. Examples of the substituent include the halogen atom, alkoxy group, alkyl group, and aryl group exemplified above.

In the hydrocarbon ring structure obtained by bonding two adjacent substituents of R¹, R², R³, R⁴, R⁵, and R⁶ in the general formula (1), examples of a group that connects the substituents to each other include a single bond, a 2,2′-methylene group, a 2,2′-ethylene group, a 2,2′-vinylene group. Among these, a 2,2′-methylene group is desired.

In the general formula (1), R¹, R², R³, R⁴, R⁵, and R⁶ are suitably a hydrogen atom or a methyl group.

Specific examples of the charge transporting material represented by the general formula (1) are shown below, but the charge transporting material is not limited thereto.

| Exemplary | | | | | | | | |
|---|---|---|---|---|---|---|---|---|
| compound | | | | | | | | |
| No. | n | m | R¹ | R² | R³ | R⁴ | R⁵ | R⁶ |
| 1-1 | 1 | 1 | H | H | H | H | H | H |
| 1-2 | 2 | 2 | H | H | H | H | H | H |
| 1-3 | 1 | 1 | 4-Me | 4-Me | 4-Me | H | H | H |
| 1-4 | 2 | 2 | H | H | H | H | 4-Me | 4-Me |
| 1-5 | 1 | 0 | H | H | H | H | H | H |
| 1-6 | 1 | 0 | 4-Me | 4-Me | 4-Me | 4-Me | 4-Me | 4-Me |
| 1-7 | 1 | 0 | 4-Me | 4-Me | H | H | 4-Me | 4-Me |
| 1-8 | 1 | 0 | H | H | 4-Me | 4-Me | H | H |
| 1-9 | 1 | 0 | H | H | 3-Me | 3-Me | H | H |
| 1-10 | 1 | 0 | 4-Me | H | H | H | 4-Me | H |
| 1-11 | 1 | 0 | 4-MeO | H | H | H | 4-MeO | H |
| 1-12 | 1 | 0 | H | H | 4-MeO | 4-MeO | H | H |
| 1-13 | 1 | 0 | 4-MeO | H | 4-MeO | H | 4-MeO | 4-MeO |
| 1-14 | 1 | 0 | 3-Me | H | 3-Me | H | 3-Me | H |
| 1-15 | 1 | 1 | 4-Me | 4-Me | 4-Me | 4-Me | 4-Me | 4-Me |
| 1-16 | 1 | 1 | 4-Me | 4-Me | H | H | 4-Me | 4-Me |
| 1-17 | 1 | 1 | H | H | 4-Me | 4-Me | H | H |
| 1-18 | 1 | 1 | H | H | 3-Me | 3-Me | H | H |
| 1-19 | 1 | 1 | 4-Me | H | H | H | 4-Me | H |
| 1-20 | 1 | 1 | 4-MeO | H | H | H | 4-MeO | H |
| 1-21 | 1 | 1 | H | H | 4-MeO | 4-MeO | H | H |
| 1-22 | 1 | 1 | 4-MeO | H | 4-MeO | H | 4-MeO | 4-MeO |
| 1-23 | 1 | 1 | 3-Me | H | 3-Me | H | 3-Me | H |

The content of the charge transporting material having a butadiene trimer structure in a single molecule is, for example, 5% or more and 45% or less by mass or about 5% or more and about 45% or less by mass and preferably 10% or more and 40% or less by mass relative to the total solid content of the outermost surface layer (charge transporting layer).

In addition to the charge transporting material having a butadiene trimer structure in a single molecule, other charge transporting materials may be used together.

Examples of the other charge transporting materials include hole transporting materials including oxadiazole derivatives such as 2,5-bis(p-diethylaminophenyl)-1,3,4-oxadiazole, pyrazoline derivatives such as 1,3,5-triphenyl-pyrazoline and 1-[pyridyl-(2)]-3-(p-diethylaminostyryl)-5-(p-diethylaminostyryl)pyrazoline, aromatic tertiary amino compounds such as triphenylamine, N,N′-bis(3,4-dimethylphenyl)biphenyl-4-amine, tri(p-methylphenyl)aminyl-4-amine, and dibenzylaniline, aromatic tertiary diamino compounds such as N,N′-bis(3-methylphenyl)-N,N′-diphenylbenzidine, 1,2,4-triazine derivatives such as 3-(4′-dimethylaminophenyl)-5,6-di-(4′-methoxyphenyl)-1,2,4-triazine, hydrazone derivatives such as 4-diethylaminobenzaldehyde-1,1-diphenylhydrazone, quinazoline derivatives such as 2-phenyl-4-styryl-quinazoline, benzofuran derivatives such as 6-hydroxy-2,3-di(p-methoxyphenyl)benzofuran, α-stilbene derivatives such as p-(2,2-diphenylvinyl)-N,N-diphenylaniline, enamine derivatives, carbazole derivatives such as N-ethylcarbazole, and poly-N-vinylcarbazole and the derivatives thereof; electron transporting materials including quinone compounds such as chloranil and bromoanthraquinone, tetracyanoquinodimethane compounds, fluorenone compounds such as 2,4,7-trinitrofluorenone and 2,4,5,7-tetranitro-9-fluorenone, xanthone compounds, and thiophene compounds; and polymers having a group composed of the above-described compounds as the main chain or side chain thereof. The other charge transporting materials may be used alone or in combination.

A binder resin is described. The binder resin is a polycarbonate resin having a structural unit (repeating unit) represented by the following general formula (A) (hereinafter, this binder resin is referred to as “specific polycarbonate resin”).

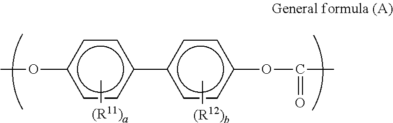

In the general formula (A), R¹¹ and R¹² each independently represent a halogen atom, an alkyl group having 1 to 6 carbon atoms, a cycloalkyl group having 5 to 7 carbon atoms, or an aryl group having 6 to 12 carbon atoms;

and a and b each independently represent an integer of 0 to 4.

In the general formula (A), R¹¹ and R¹² each independently preferably represent an alkyl group having 1 to 6 carbon atoms and more preferably a methyl group.

In the general formula (A), a and b each independently preferably represent an integer of 0 to 2.

Specifically, a structural unit represented by the following structural formula (Al) is preferably used as the structural unit represented by the general formula (A).

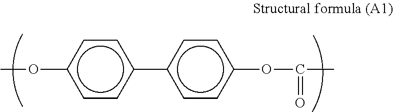

The specific polycarbonate resin is not particularly limited as long as it has the structural unit represented by the general formula (A). To improve the mechanical strength of the outermost surface layer and thus suppress the abrasion, a copolymer having the structural unit represented by the general formula (A) and a structural unit represented by the following general formula (B) may be used.

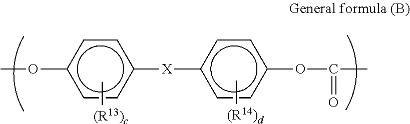

In the general formula (B), R¹³ and R¹⁴ each independently represent a halogen atom, an alkyl group having 1 to 6 carbon atoms, a cycloalkyl group having 5 to 7 carbon atoms, or an aryl group having 6 to 12 carbon atoms; and c and d each independently represent an integer of 0 to 4.

X represents —CR¹⁵R¹⁶—(R¹⁵ and R¹⁶ each independently represent a hydrogen atom, a trifluoromethyl group, an alkyl group having 1 to 6 carbon atoms, or an aryl group having 6 to 12 carbon atoms), a 1,1-cycloalkylene group having 5 to 11 carbon atoms, an α,ω-alkylene group having 2 to 10 carbon atoms, —O—, —S—, —SO—, or —SO₂—.

In the general formula (B), R¹³ and R¹⁴ each independently preferably represent an alkyl group having 1 to 6 carbon atoms and more preferably a methyl group; and c and d each independently preferably represent an integer of 0 to 2.

In the general formula (B), X preferably represents —CR¹⁵R¹⁶— or a 1,1-cycloalkylene group having 5 to 11 carbon atoms and more preferably —CR¹⁵R¹⁶—. R¹⁵ and R¹⁶ in —CR¹⁵R¹⁶— each independently preferably represent an alkyl group having 1 to 6 carbon atoms or an aryl group having 6 to 12 carbon atoms and more preferably a methyl group or a phenyl group.

Specifically, structural units represented by the following structural formulae (B1) to (B3) are preferably used as the structural unit represented by the general formula (B).

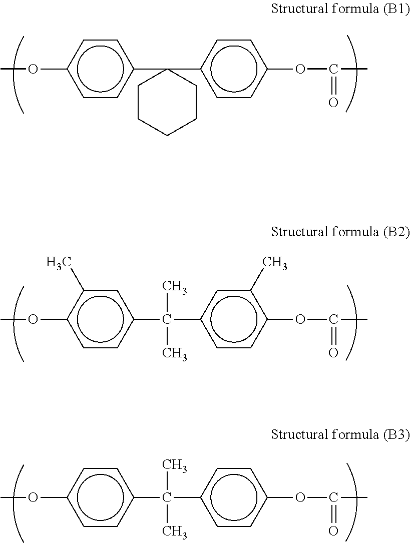

Herein, the polycarbonate resin, which is a copolymer having the structural unit represented by the general formula (A) and the structural unit represented by the general formula (B), is obtained as follows. For example, a 4,4′-dihydroxybiphenyl compound represented by the following general formula (2A) and a bisphenol compound represented by the following general formula (2B) are used as raw materials, and polycondensation with a carbonic acid ester-forming compound such as phosgene or transesterification with bisaryl carbonate is performed.

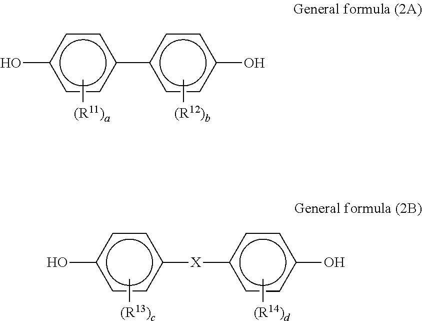

In the general formulae (2A) and (2B), R¹¹, R¹², R¹³, R¹⁴, a, b, c, d, and X are the same as those in the general formulae (A) and (B).

Specific examples of the 4,4′-dihydroxybiphenyl compound represented by the general formula (2A) include 4,4′-dihydroxybiphenyl, 4,4′-dihydroxy-3,3′-dimethylbiphenyl, 4,4′-dihydroxy-2,2′-dimethylbiphenyl, 4,4′-dihydroxy-3,3′-dicyclohexylbiphenyl, 3,3′-difluoro-4,4′-dihydroxybiphenyl, and 4,4′-dihydroxy-3,3′-diphenylbiphenyl.

Specific examples of the bisphenol compound represented by the general formula (2B) include bis(4-hydroxyphenyl)methane, 1,1-bis(4-hydroxyphenyl)ethane, 1,2-bis(4-hydroxyphenyl)ethane, 2,2-bis(4-hydroxyphenyl)propane, 2,2-bis(3-methyl-4-hydroxyphenyl)butane, 2,2-bis(4-hydroxyphenyl)butane, 2,2-bis(4-hydroxyphenyl)octane, 4,4-bis(4-hydroxyphenyl)heptane, 1,1-bis(4-hydroxyphenyl)-1,1-diphenylmethane, 1,1-bis(4-hydroxyphenyl)-1-phenylethane, 1,1-bis(4-hydroxyphenyl)-1-phenylmethane, bis(4-hydroxyphenyl)ether, bis(4-hydroxyphenyl)sulfide, bis(4-hydroxyphenyl)sulfone, 1,1-bis(4-hydroxyphenyl)cyclopentane, 1,1-bis(4-hydroxyphenyl)cyclohexane, 2,2-bis(3-methyl-4-hydroxyphenyl)propane, 2-(3-methyl-4-hydroxyphenyl)-2-(4-hydroxyphenyl)-1-phenylethane, bis(3-methyl-4-hydroxyphenyl)sulfide, bis(3-methyl-4-hydroxyphenyl)sulfone, bis(3-methyl-4-hydroxyphenyl)methane, 1,1-bis(3-methyl-4-hydroxyphenyl)cyclohexane, 2,2-bis(2-methyl-4-hydroxyphenyl)propane, 1,1-bis(2-butyl-4-hydroxy-5-methylphenyl)butane, 1,1-bis(2-tert-butyl-4-hydroxy-3-methylphenyl)ethane, 1,1-bis(2-tert-butyl-4-hydroxy-5-methylphenyl)propane, 1,1-bis(2-tert-butyl-4-hydroxy-5-methylphenyl)butane, 1,1-bis(2-tert-butyl-4-hydroxy-5-methylphenyl)isobutane, 1,1-bis(2-tert-butyl-4-hydroxy-5-methylphenyl)heptane, 1,1-bis(2-tert-butyl-4-hydroxy-5-methylphenyl)-1-phenylmethane, 1,1-bis(2-tert-amyl-4-hydroxy-5-methylphenyl)butane, bis(3-chloro-4-hydroxyphenyl)methane, bis(3,5-dibromo-4-hydroxyphenyl)methane, 2,2-bis(3-chloro-4-hydroxyphenyl)propane, 2,2-bis(3-fluoro-4-hydroxyphenyl)propane, 2,2-bis(3-bromo-4-hydroxyphenyl)propane, 2,2-bis(3,5-difluoro-4-hydroxyphenyl)propane, 2,2-bis(3,5-dichloro-4-hydroxyphenyl)propane, 2,2-bis(3,5-dibromo-4-hydroxyphenyl)propane, 2,2-bis(3-bromo-4-hydroxy-5-chlorophenyl)propane, 2,2-bis(3,5-dichloro-4-hydroxyphenyl)butane, 2,2-bis(3,5-dibromo-4-hydroxyphenyl)butane, 1-phenyl-1,1-bis(3-fluoro-4-hydroxyphenyl)ethane, bis(3-fluoro-4-hydroxyphenyl)ether, and 1,1-bis(3-cyclohexyl-4-hydroxyphenyl)cyclohexane. These bisphenol compounds may be used alone or in combination.

In the specific polycarbonate resin, the copolymerization ratio of the structural unit represented by the general formula (A) to all the structural units constituting the polycarbonate resin is 5% or more and 95% or less by mole. To improve the mechanical strength of the outermost surface layer and thus suppress the abrasion, the ratio is preferably 5% or more and 50% or less by mole and more preferably 15% or more and 25% or less by mole or about 15% or more and about 25% or less by mole.

The specific polycarbonate resin is exemplified below, but is not limited thereto. Note that m and n in the exemplary compounds represent a copolymerization ratio.

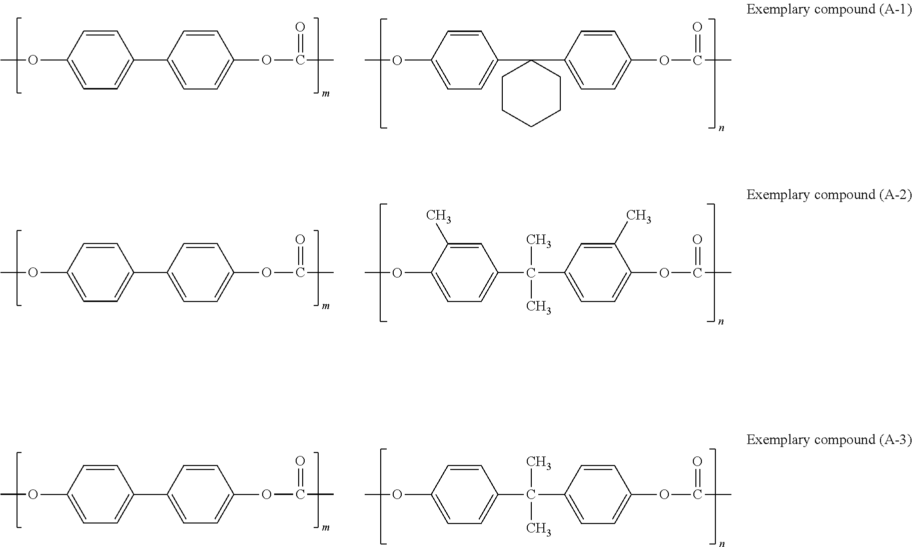

In the above-described exemplary compounds, m:n is in the range of 95:5 to 5:95, preferably 50:50 to 5:95, and more preferably 15:85 to 25:75.

The weight-average molecular weight of the specific polycarbonate resin is preferably 20000 or more and 1200000 or less, more preferably 40000 or more and 100000 or less, and particularly preferably 60000 or more and 80000 or less.

Other binder resins may be used together with the specific polycarbonate resin as long as the function is not impaired. Examples of the other binder resin include bisphenol A or bisphenol Z polycarbonate resin, acrylic resin, methacrylic resin, polyarylate resin, polyester resin, polyvinyl chloride resin, polystyrene resin, acrylonitrile-styrene copolymer resin, acrylonitrile-butadiene copolymer resin, polyvinyl acetate resin, polyvinyl formal resin, polysulfone resin, styrene-butadiene copolymer resin, vinylidene chloride-acrylonitrile copolymer resin, vinyl chloride-vinyl acetate-maleic anhydride resin, silicone resin, phenol-formaldehyde resin, polyacrylamide resin, polyamide resin, insulating resin such as chlorine rubber, and organic photoconductive polymers such as polyvinyl carbazole, polyvinyl anthracene, and polyvinyl pyrene. The other binder resins may be used alone or in combination.

The content of the specific polycarbonate resin is, for example, 10% or more and 90% or less by mass, preferably 30% or more and 90% or less by mass or about 30% or more and about 90% or less by mass, and more preferably 50% or more and 90% or less by mass relative to the total solid content of the outermost surface layer (charge transporting layer).

The compounding ratio (mass ratio) of the charge transporting material to the binder resin (the specific polycarbonate resin and other binder resins) is suitably 10:1 to 1:5.

Other additives are described. The charge transporting layer may contain fluorocarbon resin particles to improve the mechanical strength of the outermost surface layer and thus suppress the abrasion.

The fluorocarbon resin particles are suitably selected from, for example, one or more types of particles of tetrafluoroethylene resin, chlorotrifluoroethylene resin, hexafluoropropylene resin, vinyl fluoride resin, vinylidene fluoride resin, and dichlorodifluoroethylene resin and particles of the copolymer thereof. Among these, tetrafluoroethylene resin particles and vinylidene fluoride resin particles are particularly preferred as the fluorocarbon resin particles.

The primary particle size of the fluorocarbon resin particles is 0.05 μm or more and 1 μm or less or about 0.05 μm or more and about 1 μm or less and preferably 0.1 μm or more and 0.5 μm or less.

The primary particle size is an average value of the maximum particle sizes of 50 fluorocarbon resin particles in a primary particle state. The maximum particle sizes are determined by observing a sample piece from the outermost surface layer (charge transporting layer) of the electrophotographic photoconductor using a scanning electron microscope (SEM) at a magnification of 5000 times or more. JSM-6700F manufactured by JEOL Ltd. is used as the SEM, and a secondary electron image obtained at an acceleration voltage of 5 kV is observed.

A fluorine-based graft polymer as a dispersant may be used together with the fluorocarbon resin particles. The amount of the dispersant is not particularly specified, but is 0.1% or more and 10% or less by mass relative to the amount of the fluorocarbon resin particles.

The content of the fluorocarbon resin particles is preferably 2% or more and 15% or less by mass or about 2% or more and about 15% or less by mass, more preferably 4% or more and 12% or less by mass, and particularly preferably 6% or more and 10% or less by mass relative to the total solid content of the charge transporting layer (outermost surface layer).

The charge transporting layer may optionally contain fluorine-modified silicone oil. An example of the fluorine-modified silicone oil is a fluorine-modified silicone oil obtained, for example, by replacing part or all of substituents in organopolysiloxane with a fluoroalkyl group (e.g., fluoroalkyl group having 1 to 10 carbon atoms).

The content of the fluorine-modified silicone oil is, for example, 0.1 ppm or more and 1000 ppm or less and preferably 0.5 ppm or more and 500 ppm or less.

The charge transporting layer is formed using a coating solution for forming the charge transporting layer obtained by adding the above-described components to a solvent.

Particles (e.g., fluorocarbon resin particles) are dispersed in the coating solution for forming the charge transporting layer using a media dispersing machine such as a ball mill, a vibrating ball mill, an attritor, a sand mill, or a horizontal sand mill or a medialess dispersing machine such as a stirrer, an ultrasonic dispersing machine, a roll mill, or a high-pressure homogenizer. High-pressure homogenizers include a collision-type homogenizer that disperses a dispersion through liquid-liquid collision or liquid-wall collision under high pressure and a penetration-type homogenizer that disperses a dispersion by forcing the dispersion through a fine channel under high pressure.

In the case where, for example, fluorocarbon resin particles are dispersed in the coating solution for forming the charge transporting layer, that is, fluorocarbon resin particles are added to the charge transporting layer, a fluorosurfactant or a fluorine-based graft polymer may be used together as a dispersion stabilizer for the fluorocarbon resin particles. Examples of the fluorine-based graft polymer include resins obtained by performing graft polymerization using perfluoroalkylethyl methacrylate and a macromonomer composed of an acrylic ester compound, a methacrylic ester compound, a styrene compound, or the like.

The content of the fluorosurfactant or fluorine-based graft polymer is, for example, 1% or more and 5% or less by mass relative to the amount of the fluorocarbon resin particles.

The coating solution for forming the charge transporting layer is applied on the charge generating layer by a typical method such as dip coating, ring coating, wire bar coating, spray coating, blade coating, knife coating, or curtain coating.

The thickness of the charge transporting layer is suitably 25 μm or more as described above, but may be, for example, 5 μm or more and less than 25 μm.

Next, a single-layer type photosensitive layer is described.

The single-layer type photosensitive layer contains, for example, a charge generating material, a binder resin having a structural unit represented by the general formula (A), and a charge transporting material having a butadiene trimer structure in a single molecule.

The content of the charge generating material in the single-layer type photosensitive layer is about 10% or more and 85% or less by mass and preferably 20% or more and 50% or less by mass. The content of the charge transporting material is preferably 5% or more and 50% or less by mass.

The thickness of the single-layer type photosensitive layer is suitably 25 μm or more as described above, but may be, for example, 5 μm or more and less than 25 μm.

Each of the layers constituting the photosensitive layer may contain additives such as a light stabilizer and a heat stabilizer. Examples of an antioxidant include arylalkanes, hydroquinones, spirochromans, spiroindanones, and the derivatives thereof; organosulfur compounds; and organophosphorus compounds. Examples of the light stabilizer include derivatives of benzophenone, benzotriazole, dithiocarbamate, and tetramethylpiperidine.

Each of the layers constituting the photosensitive layer may contain at least one electron accepting substance. Examples of the electron accepting substance include succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, and phthalic acid. Among these, benzene derivatives having an electron-withdrawing substituent such as a fluorenone-based substituent, a quinone-based substituent, Cl, CN, or NO₂ are particularly preferred.

The electrophotographic photoconductor 10 may separately include an overcoat layer on the photosensitive layer. In this case, the overcoat layer corresponds to an outermost surface layer and contains a binder resin having a structural unit represented by the general formula (A) and a charge transporting material having a butadiene trimer structure in a single molecule.

### (Charging Device)

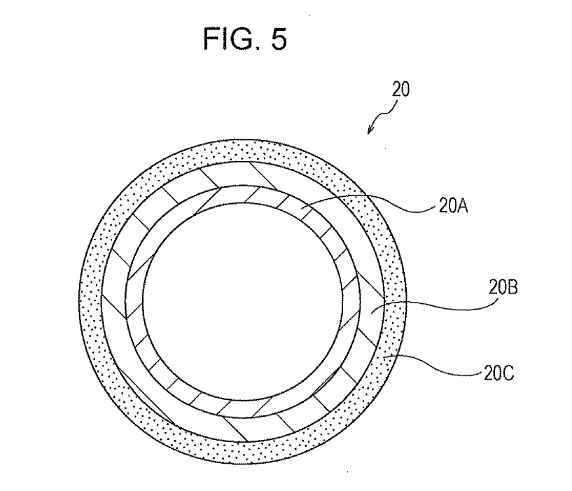

FIG. 5 schematically shows a charging device according to this exemplary embodiment.

As shown in FIG. 5, for example, a charging device 20 is a contact-type charging roller that includes a roll-shaped base 20A, a conductive elastic layer 20B formed on the peripheral surface of the base 20A, and an outermost surface layer 20C formed on the peripheral surface of the conductive elastic layer 20B.

In this exemplary embodiment, a charging roller is used as the charging device 20. However, other members having different shapes (e.g., charging film, charging rubber blade, and charging tube) may be used.

Each of the components of the charging device 20 will now be described. Note that the reference numerals are omitted.

The base is described. The base is a cylindrical member and functions as an electrode and a supporting member of the charging roller. For example, the base is composed of a metal or alloy such as aluminum, copper alloy, or stainless steel; iron plated with chromium, nickel, or the like; or a conductive material such as a conductive resin.

A conductive elastic layer is described. The conductive elastic layer contains, for example, a rubber material and a conductivity-imparting agent.

Examples of the rubber material include isoprene rubber, chloroprene rubber, epichlorohydrin rubber, butyl rubber, polyurethane, silicone rubber, fluororubber, styrene-butadiene rubber, butadiene rubber, nitrile rubber, ethylene propylene rubber, epichlorohydrin-ethyleneoxide copolymer rubber, epichlorohydrin-ethyleneoxide-allyl glycidyl ether copolymer rubber, ethylene-propylene-diene ternary copolymer rubber (EPDM), acrylonitrile-butadiene copolymer rubber (NBR), natural rubber, and the blend rubber of the foregoing.

Among these, polyurethane, silicone rubber, EPDM, epichlorohydrin-ethyleneoxide copolymer rubber, epichlorohydrin-ethyleneoxide-allyl glycidyl ether copolymer rubber, NBR, and the blend rubber of the foregoing are suitably used.

These rubber materials may be foamed or non-foamed.

These rubber materials may be used alone or in combination.

Examples of the conductivity-imparting agent include electronic conductive agents and ionic conductive agents.

Examples of the electronic conductive agents include fine particles of carbon black such as Ketjenblack and acetylene black; pyrocarbon; graphite; various conductive metals and alloys such as aluminum, copper, nickel, and stainless steel; various conductive metal oxides such as tin oxide, indium oxide, titanium oxide, tin oxide-antimony oxide solid solution, and tin oxide-indium oxide solid solution; insulating materials having surfaces treated to exhibit conductivity; and conductive polymers such as polypyrrole and polyaniline.

Examples of the ionic conductive agents include ammonium salts such as tetraethylammonium chloride and lauryltrimethylammonium chloride; and metal salts of alkali metals and alkaline-earth metals such as lithium and magnesium.

These conductivity-imparting agents may be used alone or in combination.

The amount of the conductivity-imparting agent added is not particularly limited. In the case of the electronic conductive agent, the amount is preferably 1 part or more and 30 parts or less by mass and more preferably 15 parts or more and 25 parts or less by mass relative to 100 parts by mass of the rubber material.

In the case of the ionic conductive agent, the amount is preferably 0.1 parts or more and 5.0 parts or less by mass and more preferably 0.5 parts or more and 3.0 parts or less by mass relative to 100 parts by mass of the rubber material.

When the conductive elastic layer is formed, the method and order of adding the conductivity-imparting agent, the rubber material, and other components (a vulcanizing agent and a foaming agent to be optionally added) are not particularly limited. Normally, all the components are mixed using a tumbler, a V blender, or the like in advance, and the mixture is then uniformly melt-blended using an extruder.

An outermost surface layer is described. The outermost surface layer is a layer containing a porous filler and has a surface roughness Rz of 2 μm or more and 20 μm or less or about 2 μm or more and about 20 μm or less.

The surface roughness Rz of the outermost surface layer is 2 μm or more and 20 μm or less or about 2 μm or more and about 20 μm or less, preferably 4 μm or more and 18 μm or less, and more preferably 8 μm or more and 15 μm or less. When the surface roughness Rz of the outermost surface layer is 2 μm or more and 20 μm or less or about 2 μm or more and about 20 μm or less, the contamination resistance is improved and thus the durability of a charging device is improved, which provides long-term chargeability. If the surface roughness Rz of the outermost surface layer is less than 2 μm, an effect of preventing contamination caused by a toner or an external additive of the toner is sometimes decreases. When the surface roughness Rz is more than 20 μm, the surface may be cracked as a result of long-term use.

The surface roughness Rz (ten-point mean roughness) of the outermost surface layer is controlled, for example, by adjusting the particle size of the porous filler, the amount of the porous filler added, and the thickness of the outermost surface layer.

The surface roughness Rz (ten-point mean roughness) of the outermost surface layer is measured in accordance with JIS B0601 (1994).

Specifically, the measurement device is SURFCOM 1400 manufactured by TOKYO SEIMITSU Co., Ltd. The measurement conditions are as follows: the cutoff is 0.8 mm, the measurement length is 2.4 mm, and the traverse speed is 0.3 mm/sec.

The outermost surface layer contains, for example, a binder resin and a porous filler and optionally other additives.

A binder resin is described. The binder resin is not particularly limited, and examples of the binder resin include polyamide resin, acrylic resin, and urethane resin.

The binder resin is preferably composed of a polyamide resin as a main component. Since a toner and an external additive do not readily adhere to a polyamide resin, satisfactory contamination resistance is achieved. Furthermore, since a polyamide resin causes triboelectrification through the contact with an electrophotographic photoconductor of an image forming apparatus, the electrophotographic photoconductor does not readily have a positive charge.

Herein, the “main component” is one of the binder resins constituting the outermost surface layer, the binder resin being contained in an amount of 50% or more by mass. When the entire binder resin contained in the outermost surface layer is assumed to be 100%, the ratio of the polyamide resin as a main component is preferably 50% or more and 99% or less by mass and more preferably 60% or more and 99% or less by mass.

The polyamide resin is not particularly limited, and polyamide resins described in “Polyamide Resin Handbook” edited by Osamu Fukumoto, 8400 (Nikkan Kogyo Shimbun, Ltd.) are exemplified. Among these, in order to easily form the outermost surface layer by a coating method such as dipping, the polyamide resin is preferably a solvent-soluble polyamide resin and more preferably an alcohol-soluble polyamide resin that is soluble in an alcohol such as methanol or ethanol.

Examples of the solvent-soluble polyamide resin include alcohol-soluble polyamide resins, e.g., N-alkoxyalkylated nylons obtained by alkoxyalkylating nylon such as nylon 6, nylon 11, nylon 12, nylon 6,6, or nylon 6,10 and copolymerized nylons that are copolymers containing at least two of nylon 6, nylon 11, nylon 12, nylon 6,6, and nylon 6,10.

The alcohol-soluble polyamide resin is preferably an N-alkoxymethylated nylon and more preferably an N-methoxymethylated nylon in view of long-term chargeability.

The weight-average molecular weight of the polyamide resin is suitably 10000 or more and less than 100000. If the weight-average molecular weight is less than 10000, the membrane may have low strength. If the weight-average molecular weight is more than 100000, the membrane may have low uniformity. The weight-average molecular weight is suitably lower within the above-described range because such a polyamide resin having a lower weight-average molecular weight provides higher dispersibility of a conductivity-imparting agent such as carbon black.

The binder resin preferably contains at least one of polyvinyl acetal resins, polyester resins, phenol resins, epoxy resins, melamine resins, and benzoguanamine resins as a binder resin as a second component, in addition to the binder resin as a main component. Among these resins, polyvinyl acetal resins are more preferred because a porous filler is easily dispersed. When the entire binder resin is assumed to be 100%, the ratio of the binder resin as a second component is preferably 0.01% or more and 50% or less by mass and more preferably 0.1% or more and 40% or less by mass.

In the outermost surface layer, for example, a polyamide resin such as an alcohol-soluble polyamide resin may be caused to react with the binder resin as a second component by heating to achieve crosslinking such as three-dimensional crosslinking. This improves the durability of the charging device 20 and suppresses image defects caused by, for example, surface cracking of the charging device 20.

Examples of the polyvinyl acetal resin include polyvinyl butyral resin, polyvinyl formal resin, and partially acetalized polyvinyl butyral resin obtained by modifying part of butyral with formal or acetoacetal.

An example of the polyester resin is a polyester resin containing a constituent component derived from an acid and a constituent component derived from an alcohol, and such a polyester resin may optionally contain other components.

The polyester resin is synthesized from an acid (dicarboxylic acid) component and an alcohol (dial) component. In this specification, the term “constituent component derived from an acid” refers to a moiety that has been an acid component before the synthesis of the polyester resin. The term “constituent component derived from an alcohol” refers to a moiety that has been an alcohol component before the synthesis of the polyester resin.

Examples of the phenol resin include monomers of monomethylol phenols, dimethylol phenols, and trimethylol phenols obtained by causing a reaction between formaldehyde or para-formaldehyde and a compound having a phenol structure, e.g., a substituted phenol having one hydroxyl group such as phenol, cresol, xylenol, para-alkylphenol, or para-phenylphenol, a substituted phenol having two hydroxyl groups such as catechol, resorcinol, or hydroquinone, a bisphenol such as bisphenol A or bisphenol Z, or a biphenol in the presence of an acid or alkali catalyst. Other examples of the phenol resin include mixtures of the monomers, oligomers of the monomers, and mixtures of the monomers and oligomers.

Monomers, oligomers, and polymers having two or more epoxy groups in a single molecule are referred to as the epoxy resin, and the molecular weight and molecular structure are not particularly limited. Examples of the epoxy resin include biphenyl-type epoxy resin, bisphenol-type epoxy resin, stilbene-type epoxy resin, phenol novolac-type epoxy resin, cresol novolac-type epoxy resin, triphenolmethane-type epoxy resin, alkyl-modified triphenolmethane-type epoxy resin, triazine core-containing epoxy resin, dicyclopentadiene-modified phenol-type epoxy resin, and phenolaralkyl-type epoxy resin (having a phenylene structure, a diphenylene structure, or the like). These epoxy resins may be used alone or in combination. Among these resins, biphenyl-type epoxy resin, bisphenol-type epoxy resin, stilbene-type epoxy resin, phenol novolac-type epoxy resin, cresol novolac-type epoxy resin, and triphenolmethane-type epoxy resin are preferred; biphenyl-type epoxy resin, bisphenol-type epoxy resin, phenol novolac-type epoxy resin, and cresol novolac-type epoxy resin are more preferred; and bisphenol-type epoxy resin is particularly preferred.

An example of the melamine resin is a compound having a melamine structure such as a compound represented by the following general formula (α).

An example of the benzoguanamine resin is a compound having a guanamine structure such as a compound represented by the following general formula (β).

The compounds represented by the general formulae (α) and (β) are, for example, synthesized by a usual method (e.g., refer to Jikken Kagaku Koza (Experimental Chemistry Course), 4th edition, vol. 28, pp. 430) using melamine and formaldehyde and using guanamine and formaldehyde, respectively.

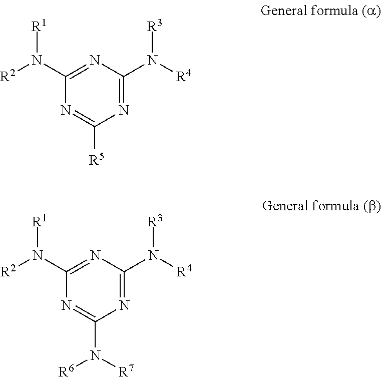

In the general formulae (α) and (β), R¹, R², R³, R⁴, R⁵, R⁶ and R⁷ each independently represent —H, —CH₂OH, or an alkyl ether group.

Specific examples of the compound represented by the general formula (a) include compounds having structures represented by (α)-1 to (α)-22 below. Specific examples of the compound represented by the general formula (β) include compounds having structures represented by (β)-1 to (β)-6 below. These compounds may be used alone or in a mixed manner. By using the compound in a mixed manner or in the form of an oligomer, the solubility in an organic solvent or the binder resin as a main component is favorably improved.

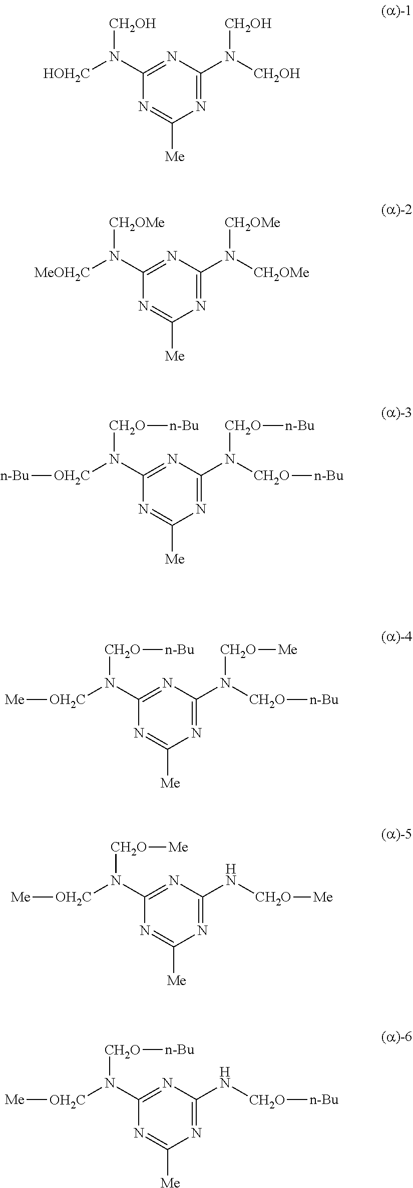

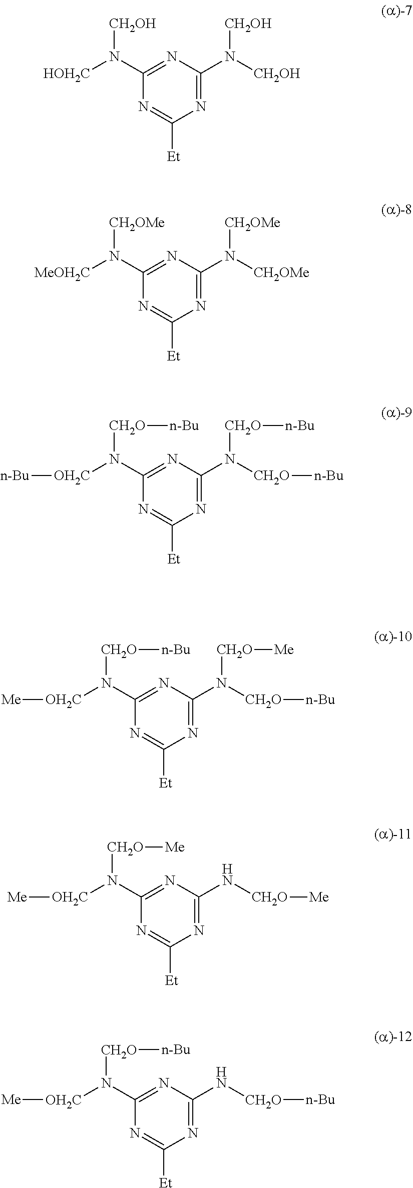

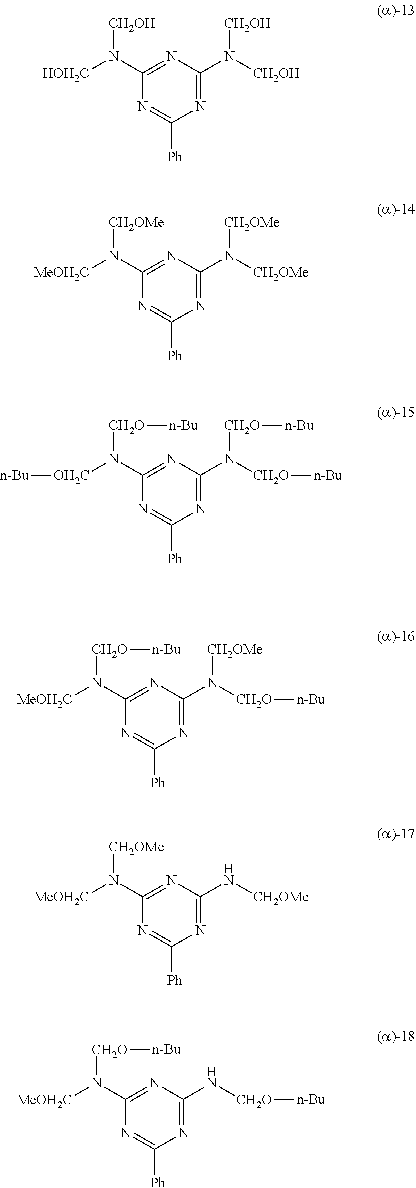

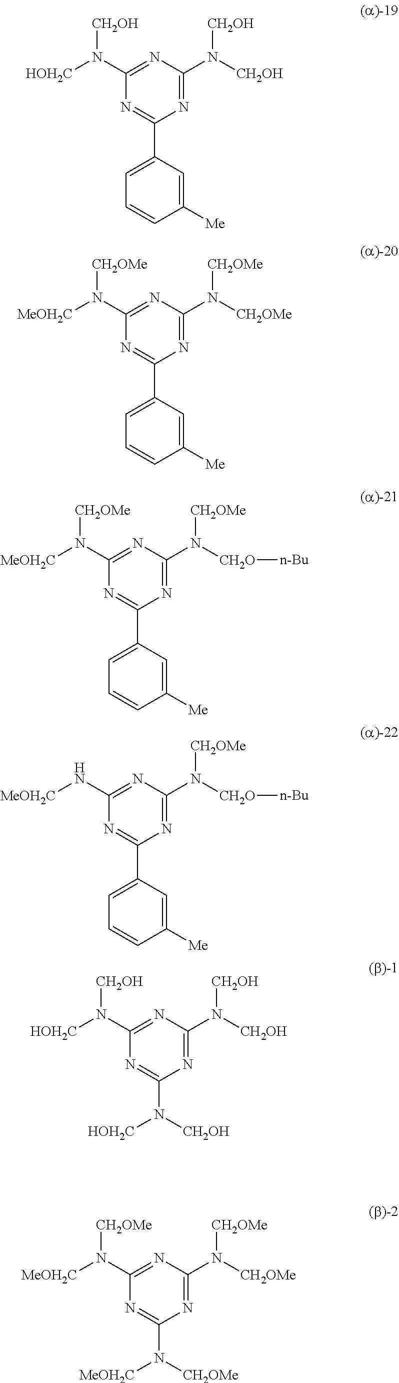

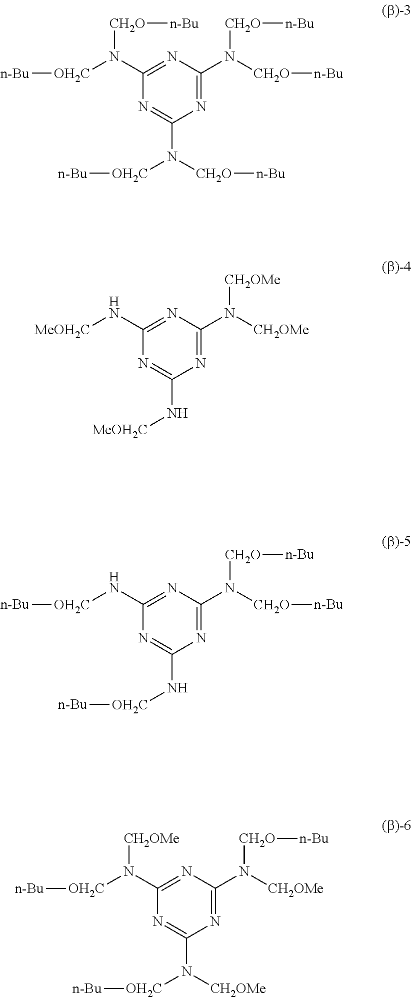

Commercially available melamine resins or benzoguanamine resins may be directly used. Examples of the melamine resins and the benzoguanamine resins include SUPER BECKAMINE (registered trademark) L-148-55, SUPER BECKAMINE (registered trademark) 13-535, SUPER BECKAMINE (registered trademark) L-145-60, SUPER BECKAMINE (registered trademark) TD-126 (available from DIC Corporation), NIKALAC BL-60, NIKALAC BX-4000 (available from NIPPON CARBIDE INDUSTRIES Co., Inc.) (above-described products are guanamine resins), SUPER MELAMI No. 90 (available from NOF Corporation), SUPER BECKAMINE (registered trademark) TD-139-60 (available from DIC Corporation), U-VAN 2020 (available from Mitsui Chemicals, Inc.), Sumitex Resin M-3 (available from Sumitomo Chemical Company, Limited), and NIKALAC MW-30 (available from NIPPON CARBIDE INDUSTRIES Co., Inc.).

A porous filler is described. The porous filler is a filler having pores in the surface thereof, the pores having a diameter less than half the diameter of the filler and a depth of 0.001 μm or more. Whether the filler is porous or not is confirmed by observing a secondary electron image using a field effect-scanning electron microscope (FE-SEM, product name: JSM-6700F manufactured by JEOL Ltd.) at an acceleration voltage of 5 kV. If the depth is less than 0.001 μm, the durability may be insufficient.

The porous filler is not particularly limited as long as the porous filler is composed of the porous material defined above. Specifically, the porous filler is at least one of porous resin particles (e.g., polyamide resin particles and acrylic resin particles) and porous inorganic particles (e.g., calcium carbonate).

When the binder resin is mainly composed of a polyamide resin, polyamide resin particles are preferably used as a porous filler in terms of high dispersibility in the binder resin as a main component. When the binder resin is mainly composed of an N-alkoxymethylated nylon, polyamide resin particles are preferably used as a porous filler because the crosslinking reaction with an N-alkoxymethylated nylon may be caused.

The porous filler may be subjected to surface treatment. The surface-treating agent may be selected from a publicly known material. Examples of the surface-treating agent include silane coupling agents, titanate coupling agents, aluminum coupling agents, and surfactants. In particular, silane coupling agents are preferably used because they provide adhesion between the binder resin and the porous filler, and silane coupling agents having an amino group are more preferably used.

Any silane coupling agent having an amino group may be used as long as it provides satisfactory adhesion between a desired binder polymer and the porous filler. Examples of the silane coupling agent include γ-aminopropyltriethoxysilane, N-β-(aminoethyl)-γ-aminopropyltrimethoxysilane, N-β-(aminoethyl)-γ-aminopropylmethyldimethoxysilane, and N,N-bis(β-hydroxyethyl)-γ-aminopropyltriethoxysilane.

The silane coupling agents may be used in combination. Examples of the silane coupling agent used together with the silane coupling agent having an amino group include vinyltrimethoxysilane, γ-methacryloxypropyl-tris(β-methoxyethoxy)silane, β-(3,4-epoxycyclohexyl)ethyltrimethoxysilane, γ-glycidoxypropyltrimethoxysilane, vinyltriacetoxysilane, γ-mercaptopropyltrimethoxysilane, γ-aminopropyltriethoxysilane, N-β-(aminoethyl)-γ-aminopropyltrimethoxysilane, N-β-(aminoethyl)-γ-aminopropylmethyldimethoxysilane, N,N-bis(β-hydroxyethyl)-γ-aminopropyltriethoxysilane, and γ-chloropropyltrimethoxysilane. However, the silane coupling agent is not limited thereto.

Any usual surface-treating method may be used. For example, a dry method or a wet method may be used.

When the entire binder resin is assumed to be 100%, the content of the porous filler is preferably 1% or more and 100% or less by mass and more preferably 3% or more and 80% or less by mass.

Other additives are described. The outermost surface layer may contain a conductivity-imparting agent. When the outermost surface layer contains a conductivity-imparting agent, the resistance is easily controlled.

Examples of the conductivity-imparting agent include the electronic conductive agents and ionic conductive agents contained in the above-described conductive elastic layer. The conductivity-imparting agent is preferably at least one of a conductive polymer, carbon black, and tin oxide in terms of resistance variation.

These conductivity-imparting agents may be used alone or in combination.

The amount of the conductivity-imparting agent added is not particularly limited. In the case of the electronic conductive agent, the amount is preferably 1 part or more and 50 parts or less by mass and more preferably 3 parts or more and 30 parts or less by mass relative to 100 parts by mass of the main component of the outermost surface layer. In the case of the ionic conductive agent, the amount is preferably 1 part or more and 50 parts or less by mass and more preferably 3 parts or more and 30 parts or less by mass relative to 100 parts by mass of the main component of the outermost surface layer.

The outermost surface layer preferably has a gel fraction of 50% or more, more preferably 60% or more, and particularly preferably 90% or more. By satisfying the gel fraction, the mechanical properties of the outermost surface layer are improved and the fatigue breaking caused as a result of long-term use is suppressed. Accordingly, the durability of a charging member is improved, which achieves excellent long-term chargeability. If the outermost surface layer has a gel fraction of less than 50%, the fatigue breaking may be caused as a result of long-term use.

The gel fraction of the outermost surface layer may be controlled by changing the amount of crosslinking. The amount of crosslinking is changed by adjusting the heating temperature and time during the formation of the outermost surface layer. In the outermost surface layer, the main component itself of the outermost surface layer, such as a polyamide resin, is believed to have a crosslinked structure. In addition, the main component of the outermost surface layer, such as a polyamide resin, is believed to have a crosslinked structure with at least one of the binder resin as a second component (if contained) and the porous filler.

The gel fraction of the outermost surface layer is measured in accordance with JIS K6796. The outermost surface layer of a charging member is cut out and the mass is measured. This mass is defined as the mass of a resin before solvent extraction. Subsequently, the outermost surface layer is immersed in a solvent (methanol in this exemplary embodiment) for 24 hours. The residual resin film is separated and collected by filtering, and the mass is measured. This mass is defined as the mass after extraction. The gel fraction is calculated using the formula below.

Gel fraction (%)=(Mass after extraction)/(Mass of resin before solvent extraction)×100

When the gel fraction, that is, the degree of crosslinking is 50% or more, the coating film has a high degree of crosslinked structure, which provides satisfactory crack resistance.

The outermost surface layer is formed, for example, by applying a curable resin composition containing a binder resin as a main component, a porous filler, and optionally a resin as a second component and a conductivity-imparting agent on the surface of a conductive elastic layer or the like and then by performing drying through heating. In the outermost surface layer, a crosslinking reaction is caused by heating. The outermost surface layer is suitably a layer crosslinked using a catalyst to facilitate the curing (crosslinking) during the drying through heating. An acid catalyst or the like may be used as the catalyst.

The outermost surface layer may be formed on a supporting member by dip coating, spray coating, vacuum deposition, or plasma deposition. Among these methods, dip coating is particularly used in terms of ease of production.

### (Exposing Device)

An example of the exposing device 30 is an optical device that exposes the surface of the electrophotographic photoconductor 10 with light such as semiconductor laser light, LED light, or liquid crystal shutter light to form a certain image. The wavelength of the light source may be within the spectral sensitivity range of the electrophotographic photoconductor 10. The wavelength of the semiconductor laser may be near infrared that has an emission wavelength near 780 nm. However, the wavelength is not limited thereto. For example, lasers having emission wavelengths on the order of 600 nm and blue lasers having emission wavelengths in the range of 400 nm to 450 nm may also be used. Moreover, for example, in order to form color images, it is also effective to use, for the exposing device 30, surface-emission laser light sources that perform multibeam outputs.

### (Developing Device)

The developing device 40 is disposed in a development region so as to face the electrophotographic photoconductor 10. The developing device 40 includes, for example, a developing container (a body of the developing device) 41 that contains a two-component developer composed of a toner and a carrier and a replenishing-developer container (toner cartridge) 47. The developing container 41 includes a developing container body 41A and a developing container cover 41B that covers the upper end of the developing container body 41A.

The developing container body 41A includes, for example, a developing roller chamber 42A that accommodates a developing roller 42, a first stirring chamber 43A adjacent to the developing roller chamber 42A, and a second stirring chamber 44A adjacent to the first stirring chamber 43A. Furthermore, a layer thickness regulating member 45 for regulating the layer thickness of a developer that is present on the surface of the developing roller 42 is disposed in the developing roller chamber 42A when the developing container cover 41B is attached to the developing container body 41A.

The first stirring chamber 43A and the second stirring chamber 44A are partitioned with, for example, a partition wall 41C. Although not shown in the drawing, the first stirring chamber 43A and the second stirring chamber 44A communicate with each other through openings formed at both ends of the partition wall 41C in the longitudinal direction of the partition wall 41C (in the longitudinal direction of the developing device). Thus, the first stirring chamber 43A and the second stirring chamber 44A constitutes a circulatory stirring chamber (43A+44A).

The developing roller 42 is disposed in the developing roller chamber 42A so as to face the electrophotographic photoconductor 10. The developing roller 42 is obtained by disposing a sleeve outside a magnetic roller (stationary magnet, not shown) having magnetism. The developer in the first stirring chamber 43A is adsorbed onto the surface of the developing roller 42 by the magnetic force of the magnetic roller and transported to the development region. In the developing roller 42, the roller shaft is rotatably supported by the developing container body 41A. Herein, the developing roller 42 and the electrophotographic photoconductor 10 each rotate in the same direction. Thus, in the portion where the developing roller 42 and the electrophotographic photoconductor 10 face each other, the developer adsorbed on the surface of the developing roller 42 is transported to the development region from a direction opposite to the rotational direction of the electrophotographic photoconductor 10.

A bias supply (not shown) is connected to the sleeve of the developing roller 42 such that a developing bias is applied (in this exemplary embodiment, a bias obtained by superimposing an alternating-current (AC) component on a direct-current (DC) component is applied so that an alternating electric field is applied to the development region).

A first stirring member (stirring/transporting member) 43 and a second stirring member (stirring/transporting member) 44 that each transport the developer while stirring it are disposed in the first stirring chamber 43A and the second stirring chamber 44A, respectively. The first stirring member 43 includes a first rotation shaft that extends in an axial direction of the developing roller 42 and a stirring/transporting blade (protrusion) fixed on a perimeter of the rotation shaft in a spiral form. Similarly, the second stirring member 44 includes a second rotation shaft and a stirring/transporting blade (protrusion). The stirring members are each rotatably supported by the developing container body 41A. The first stirring member 43 and the second stirring member 44 are disposed so that the developers contained in the first stirring chamber 43A and the second stirring chamber 44A are transported in directions opposite to each other through the rotations of the stirring members.

A supply transport path 46 is used for supplying a replenishing developer containing a replenishing toner and a replenishing carrier to the second stirring chamber 44A. The supply transport path 46 has one end connected to one end of the second stirring chamber 44A in the longitudinal direction and another end connected to the replenishing-developer container 47 that contains the replenishing developer.

In such a manner, a replenishing developer is supplied from the replenishing-developer container (toner cartridge) 47 to the developing device 40 (second stirring chamber 44A) through the supply transport path 46.

The developer used in the developing device 40 will now be described.

A two-component developer containing a toner and a carrier is employed.

First, a toner is described.

A toner includes, for example, toner particles containing a binder resin, a coloring agent, and optionally other additives such as a release agent; and optionally an external additive.

The average shape factor of the toner particles is preferably 100 or more and 150 or less, more preferably 105 or more and 145 or less, and more preferably 110 or more and 140 or less. The average shape factor is given as a number average of a shape factor expressed by (ML²/A)×(π/4)×100, where ML is the maximum length of particles and A is a projected area of particles. Furthermore, the volume-average particle size of the toner particles is preferably 3 μm or more and 12 μm or less, more preferably 3.5 μm or more and 10 μm or less, and more preferably 4 μm or more and 9 μm or less.

The toner particles are not particularly limited in terms of the production method. For example, toner particles are produced by a kneading and pulverizing method in which a mixture of a binder resin, a coloring agent, a release agent, and optionally a charge control agent is kneaded, pulverized, and classified; a method in which the shape of the particles obtained by the kneading and pulverizing method is changed by a mechanical impact force or thermal energy; an emulsion aggregation method in which emulsion polymerization is performed on a polymerizable monomer of a binder resin, and the resultant dispersion liquid, a coloring agent, a release agent, and optionally a dispersion liquid of a charge control agent are mixed to cause aggregation and heat coalescence; a suspension polymerization method in which a polymerizable monomer for obtaining a binder resin, a coloring agent, a release agent, and optionally a solution of a charge control agent are suspended in an aqueous solvent and then polymerization is performed; or a dissolving and suspending method in which a binder resin, a coloring agent, a release agent, and optionally a solution of a charge control agent are suspended in an aqueous solvent to perform granulation.

In addition, a publicly known method is also provided in which the toner particles obtained by the above-described method are used as a core, aggregated particles are made to adhere to the toner particles, and heating and coalescence are performed to provide a core-shell structure. The toner is preferably produced by a suspension polymerization method, an emulsion aggregation method, or a dissolving and suspending method that uses an aqueous solvent and more preferably by an emulsion aggregation method in view of the control of shape and particle size distribution.

A toner is produced by mixing the toner particles and the external additive using a Henschel mixer, a V blender, or the like. If the toner particles are produced by a wet method, the external additive may be added by a wet method.

Meanwhile, examples of the carrier include iron powder, glass beads, ferrite powder, nickel powder, and materials obtained by coating the surface of the foregoing with a resin. The mixing ratio between the carrier and the toner is not particularly limited, and is set in the range commonly used.

### (Transfer Device)

Examples of the first transfer device 51 and the second transfer device 52 include contact-type transfer chargers that use a belt, a roller, a film, a rubber blade, or the like and publicly known transfer chargers such as scorotron transfer chargers and corotron transfer chargers that use corona discharge.

A belt-shaped member (intermediate transfer belt) containing a conductive agent and composed of polyimide, polyamide-imide, polycarbonate, polyarylate, polyester, or rubber is used as the intermediate transfer body 50. The intermediate transfer body may have a cylindrical shape instead of a belt shape.

### (Cleaning Device)

The cleaning device 70 includes a housing 71, a cleaning blade 72 disposed so as to protrude from the housing 71, and a lubricant-supplying device 60 disposed on the upstream side of the cleaning blade 72 in the rotational direction of the electrophotographic photoconductor 10.

The cleaning blade 72 may be supported at the end portion of the housing 71 or may be supported by a supporting member (holder) prepared separately. In this exemplary embodiment, the cleaning blade 72 is supported at the end portion of the housing 71.

First, the cleaning blade 72 is described.

The cleaning blade 72 is composed of a material such as urethane rubber, silicon rubber, fluorocarbon rubber, propylene rubber, or butadiene rubber. Among these materials, urethane rubber is suitable.

The urethane rubber (polyurethane) is not particularly limited as long as it is used for forming polyurethane. An example of the urethane rubber is a urethane prepolymer composed of a polyol such as polyester polyol (e.g., polyethylene adipate or polycaprolactone) and an isocyanate such as diphenylmethane diisocyanate. The urethane rubber (polyurethane) may be obtained by using a cross-linking agent such as 1,4-butanediol, trimethylolpropane, ethylene glycol, or a mixture thereof as a raw material.

Next, the lubricant-supplying device 60 is described.

For example, the lubricant-supplying device 60 is disposed inside the cleaning device 70 and on the upstream side of the cleaning blade 72 in the rotational direction of the electrophotographic photoconductor 10.

The lubricant-supplying device 60 is constituted by, for example, a rotating brush 61 disposed so as to be in contact with the electrophotographic photoconductor 10 and a solid lubricant 62 disposed so as to be in contact with the rotating brush 61. In the lubricant-supplying device 60, the rotating brush 61 is rotated while being in contact with the solid lubricant 62, whereby the lubricant 62 is attached to the rotating brush 61. The attached lubricant 62 is supplied to the surface of the electrophotographic photoconductor 10 and thus a film of the lubricant 62 is formed.

The lubricant-supplying device 60 is not limited to the above-described configuration, and, for example, a rubber roller may be used instead of the rotating brush 61.

An operation of the image forming apparatus 101 according to this exemplary embodiment will now be described. An electrophotographic photoconductor 10 is rotated in a direction indicated by an arrow a and at the same time negatively charged by a charging device 20.

The surface of the electrophotographic photoconductor 10 negatively charged by the charging device 20 is exposed by an exposing device 30, and therefore a latent image is formed on the surface.

When a portion of the electrophotographic photoconductor 10 where the latent image has been formed approaches a developing device 40, a toner is attached to the latent image by the developing device 40 (developing roller 42) and thus a toner image is formed.

When the electrophotographic photoconductor 10 on which the toner image has been formed is further rotated in the direction indicated by an arrow a, the toner image is transferred to the outer surface of an intermediate transfer body 50.

After the toner image is transferred to the intermediate transfer body 50, recording paper P is supplied to a second transfer device 52 by a recording paper supplying device 53 and the toner image transferred to the intermediate transfer body 50 is transferred onto the recording paper P by the second transfer device 52. Thus, the toner image is formed on the recording paper P.

The toner image formed on the recording paper P is fixed by a fixing device 80.

After the toner image is transferred to the intermediate transfer body 50, the lubricant 62 is supplied to the surface of the electrophotographic photoconductor 10 by the lubricant-supplying device 60 and thus a film of the lubricant 62 is formed on the surface of the electrophotographic photoconductor 10. Subsequently, a toner left on the surface and discharge products are removed by the cleaning blade 72 of the cleaning device 70. After that, the electrophotographic photoconductor 10 is charged again by the charging device 20 and exposed by the exposing device 30. Thus, a latent image is formed again.

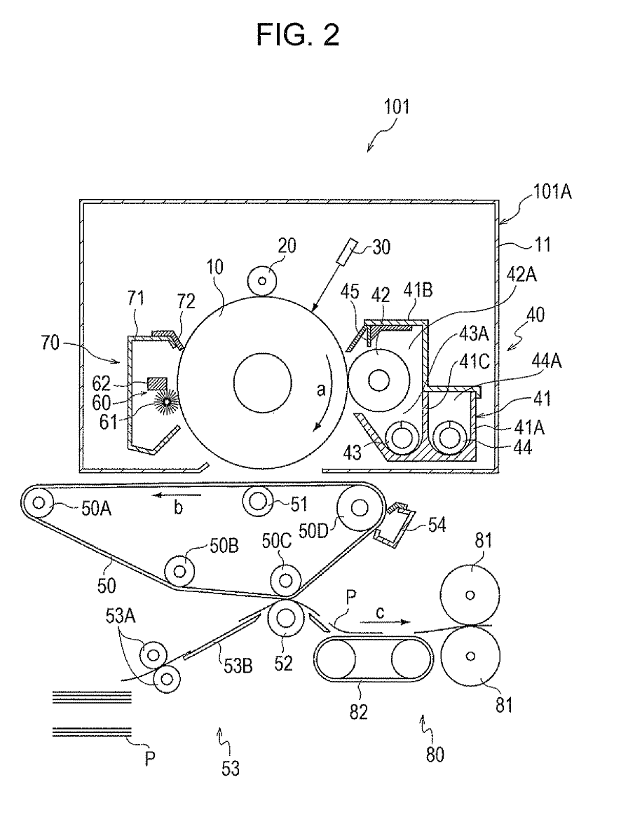

As shown in FIG. 2, for example, the image forming apparatus 101 according to this exemplary embodiment may have a process cartridge 101A obtained by accommodating the electrophotographic photoconductor 10, the charging device 20, the developing device 40, the lubricant-supplying device 60, and the cleaning device 70 in a housing 11 in an integrated manner. The process cartridge 101A accommodates multiple members in an integrated manner and is detachably mounted in the image forming apparatus 101. In the image forming apparatus 101 shown in FIG. 2, a configuration in which the replenishing-developer container 47 is not disposed in the developing device 40 is described.

The configuration of the process cartridge 101A is not limited thereto. For example, the process cartridge 101A needs only to include at least the electrophotographic photoconductor 10 and the charging device 20 and may further include at least one selected from the exposing device 30, the developing device 40, the first transfer device 51, and the cleaning device 70.

The image forming apparatus 101 according to this exemplary embodiment is not limited to the above-described configurations. For example, a first charge eraser that makes the polarity of the toner left uniform to allow a cleaning brush to easily remove the toner may be disposed at a position on the perimeter of the electrophotographic photoconductor 10, on the downstream side of the first transfer device 51 in the rotational direction of the electrophotographic photoconductor 10, and on the upstream side of the cleaning device 70 in the rotational direction of the electrophotographic photoconductor 10. A second charge eraser that removes the electricity on the surface of the electrophotographic photoconductor 10 may be disposed at a position on the downstream side of the cleaning device 70 in the rotational direction of the electrophotographic photoconductor 10 and on the upstream side of the charging device 20 in the rotational direction of the electrophotographic photoconductor 10.

The image forming apparatus 101 according to this exemplary embodiment is not limited to the above-described configurations, and a publicly known configuration may be employed. For example, a toner image formed on the electrophotographic photoconductor 10 may be directly transferred to recording paper P, or a tandem image forming apparatus may be employed.

### EXAMPLES

The present invention will now be specifically described based on Examples and Comparative Examples, but is not limited to Examples and Comparative Examples below. In the description below, “part” means “part by mass” unless otherwise specified.

### [Preparation of Photoconductor]

### (Preparation of Photoconductor 1)

One hundred parts by mass of zinc oxide (available from TAYCA Corporation, average particle size: 70 nm, specific surface: 15 m²/g) and 500 parts by mass of methanol are mixed and stirred. Subsequently, 1.25 parts by mass of a silane coupling agent (KBM 603 available from Shin-Etsu Chemical Co., Ltd.) is added to the resulting solution and stirred for 2 hours. Methanol is then removed by reduced-pressure distillation, and baking is performed at 120° C. for 3 hours to obtain zinc oxide particles surface-treated with a silane coupling agent.

Thirty eight parts by mass of a solution obtained by dispersing 60 parts by mass of the surface-treated zinc oxide particles and dissolving 0.6 parts by mass of alizarin, 13.5 parts by mass of block isocyanate (Sumidur 3173 available from Sumitomo Bayer Urethane Co., Ltd.) as a curing agent, and 15 parts by mass of butyral resin (BM-1 available from Sekisui Chemical Co., Ltd.) in 85 parts by mass of methyl ethyl ketone is mixed with 25 parts by mass of methyl ethyl ketone. The resulting mixture is dispersed in a sand mill using glass beads having a diameter of 1 mm for 4 hours to obtain a dispersion liquid. Next, 0.005 parts by mass of dioctyltin dilaurate as a catalyst and 4.0 parts by mass of silicone resin particles (Tospearl 145 available from GE Toshiba Silicones Co., Ltd.) are added to the resulting dispersion liquid to obtain a coating solution for forming an undercoating layer. The coating solution is applied on an aluminum base having a diameter of 30 mm by dip coating, and dried and cured at 180° C. for 40 minutes to form an undercoating layer having a thickness of 23 μm.

A mixture of 15 parts by mass of a chlorogallium phthalocyanine crystal having strong diffraction peaks at Bragg angles (2θ±0.2°) of at least 7.4°, 16.6°, 25.5°, and 28.3° in the X-ray diffraction spectrum measured using a CuKα characteristic X-ray, 10 parts by mass of vinyl chloride-vinyl acetate copolymer resin (VMCH available from Nippon Unicar Company Limited), and 300 parts by mass of n-butyl alcohol is dispersed in a sand mill using glass beads having a diameter of 1 mm for 4 hours to obtain a coating solution for forming a charge generating layer. The coating solution for forming a charge generating layer is applied on the undercoating layer by dip coating and dried to form a charge generating layer having a thickness of 0.2 μm.

Next, an A solution and a B solution are prepared as materials for forming a charge transporting layer. Regarding the A solution, 1.0 part by mass of tetrafluoroethylene resin particles (average particle size: 0.2 μm) and 0.01 parts by mass of a fluorine-based graft polymer (GF300 available from TOAGOSEI Co., Ltd., weight-average molecular weight: 30,000) are mixed with 4 parts by mass of tetrahydrofuran and 1 part by mass of toluene and stirred at a liquid temperature of 20° C. for 48 hours to obtain a suspension of tetrafluoroethylene resin particles.

Regarding the B solution, 2 parts by mass of a compound (the exemplary compound 1-1 described above) represented by the following structural formula (1) and used as a charge transporting material (charge transporting material having a butadiene trimer structure in a single molecule), 2 parts by mass of N,N′-bis(3-methylphenyl)-N,N′-diphenylbenzidine used as another charge transporting material, 6 parts by mass of biphenyl-copolymerized polycarbonate resin (binder resin) represented as the following exemplary compound (A-1) and having a copolymerization ratio of m:n=25:75 (weight-average molecular weight: 62,000), and 0.1 parts by mass of 2,6-di-t-butyl-4-methylphenol are mixed with each other and then dissolved in 24 parts by mass of tetrahydrofuran and 11 parts by mass of toluene.

The A solution is added to the B solution and then mixed and stirred. The mixed solution is subjected to dispersion treatment, which is performed six times at a pressure of 500 kgf/cm² using a high-pressure homogenizer (manufactured by YOSHIDA KIKAI Co., Ltd.) equipped with a penetration chamber having a fine channel. Subsequently, 10 ppm of fluorine-modified silicone oil (product name: FL-100 available from Shin-Etsu Silicone Co., Ltd.) is added to the resultant solution and stirred to obtain a coating solution for forming a charge transporting layer. The coating solution is applied on the charge generating layer, and dried at 115° C. for 40 minutes to form a charge transporting layer having a thickness of 20 μm. Thus, a photoconductor 1 is prepared.

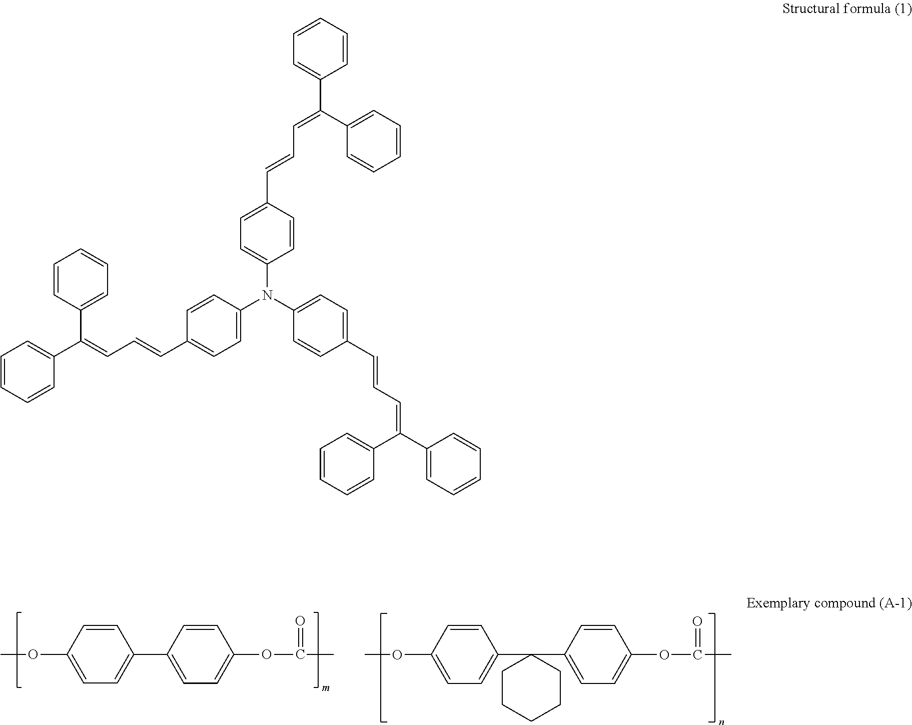

### (Preparation of Photoconductor 2)

A photoconductor 2 is prepared by the same method as that of the photoconductor 1, except that a biphenyl-copolymerized polycarbonate resin represented as the exemplary compound (A-1) and having a copolymerization ratio of m:n=15:85 (weight-average molecular weight: 52,000) is used instead of the biphenyl-copolymerized polycarbonate resin in the formation of the charge transporting layer of the photoconductor 1.

### (Preparation of Photoconductor 3)

A photoconductor 3 is prepared by the same method as that of the photoconductor 1, except that a biphenyl-copolymerized polycarbonate resin represented as the exemplary compound (A-1) and having a copolymerization ratio of m:n=5:95 (weight-average molecular weight: 48,000) is used instead of the biphenyl-copolymerized polycarbonate resin in the formation of the charge transporting layer of the photoconductor 1.

### (Preparation of Photoconductor 4)

A photoconductor 4 is prepared by the same method as that of the photoconductor 1, except that a polycarbonate resin represented as the exemplary compound (A-1) and having a copolymerization ratio of m:n=0:100 (weight-average molecular weight: 40,000) is used instead of the biphenyl-copolymerized polycarbonate resin in the formation of the charge transporting layer of the photoconductor 1.

### (Preparation of Photoconductor 5)

A photoconductor 5 is prepared by the same method as that of the photoconductor 1, except that a biphenyl-copolymerized polycarbonate resin represented as the following exemplary compound (A-2) and having a copolymerization ratio of m:n=25:75 (weight-average molecular weight: 74,000) is used instead of the biphenyl-copolymerized polycarbonate resin in the formation of the charge transporting layer of the photoconductor 1.

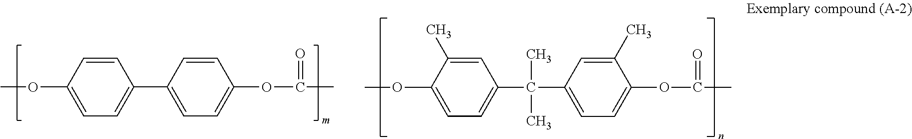

### (Preparation of Photoconductor 6)

A photoconductor 6 is prepared by the same method as that of the photoconductor 1, except that the compound represented by the structural formula (1) is not added and the amount of N,N′-bis(3-methylphenyl)-N,N′-diphenylbenzidine is changed to 4 parts by mass in the formation of the charge transporting layer of the photoconductor 1.

### (Preparation of Photoconductor 7)

A photoconductor 7 is prepared by the same method as that of the photoconductor 1, except that tetrafluoroethylene resin particles are not added (no fluorine is contained) in the formation of the charge transporting layer of the photoconductor 1.

Table 1 lists the structure of the polycarbonate resin used in the production of each of the photoconductors, the copolymerization ratio m:n, and the amount of fluorocarbon resin particles.

TABLE 1

| | | | Mass ratio of charge transporting | Amount of | |
|---|---|---|---|---|---|
| | | | material having a butadiene trimer | fluorocarbon | |
| | | | structure in a single molecule | resin particles | |
| | | Copolymerization | relative to the entire charge | (parts by | |
| Photoconductor | Structure | ratio m:n | transporting material | mass) | Remarks |
| Photoconductor 1 | (A-1) | 25:75 | 2 | 1.0 | Example |
| Photoconductor 2 | (A-1) | 15:85 | 2 | 1.0 | Example |
| Photoconductor 3 | (A-1) | 5:95 | 2 | 1.0 | Example |
| Photoconductor 4 | (A-1) | 0:100 | 2 | 1.0 | Comparative Example |
| Photoconductor 5 | (A-2) | 25:75 | 2 | 1.0 | Example |
| Photoconductor 6 | (A-1) | 25:75 | 0 | 1.0 | Comparative Example |
| Photoconductor 7 | (A-1) | 25:75 | 2 | 0 | Example |

### [Preparation of Charging Device (Charging Roller)]

### [Preparation of Conductive Elastic Roller A]

A mixture of 95.6 parts by mass of epichlorohydrin rubber (Gechron 3106 available from ZEON Corporation), 4.4 parts by mass of nitrile butadiene rubber (N250S available from JSR Corporation), 0.9 parts by mass of benzyltriethylammonium chloride (available from KANTO CHEMICAL Co., Inc.), 15 parts by mass of carbon black (Ketjenblack EC available from Lion Corporation), 0.5 parts by mass of sulfur (Sulfax PS available from TSURUMI CHEMICAL INDUSTRY Co., Ltd.), 1.5 parts by mass of tetramethylthiuram disulfide (NOCCELER TT available from OUCHI SHINKO CHEMICAL INDUSTRIAL Co., Ltd.), 1.5 parts by mass of dibenzothiazolyl disulfide (NOCCELER DM available from OUCHI SHINKO CHEMICAL INDUSTRIAL Co., Ltd.), 20 parts by mass of calcium carbonate (Silver-W available from Shiraishi Kogyo Kaisha, Ltd.), 1 part by mass of stearic acid (available from KANTO CHEMICAL Co., Inc.), and 5 parts by mass of zinc oxide (available from Seido Chemical Industry Co., Ltd.) is kneaded using an open roller, and then pressed on the surface of a conductive support made of SUS303 and having a diameter of 8 mm with an adhesive layer therebetween using a press molding machine to form a roller having a diameter of 12.5 mm. The roller is ground to obtain a conductive elastic roller having a diameter of 12 mm and a thickness of 3 mm.

### (Preparation of Charging Roller 1)

F30K (N-methoxymethylated nylon): 100 parts by mass
polyvinyl butyral resin: 10 parts by mass
carbon black: 17 parts by mass
polyamide resin particles 1 (2001UDNAT1 available from Arkema, porous filler): 33 parts by mass
acid catalyst (Nacure 4167 available from King Industry Co., Ltd.): 4.4 parts by mass

Fifteen parts by mass of a mixture of the above-described materials is diluted with 85 parts by mass of methanol and dispersed using a bead mill to obtain a dispersion liquid. The dispersion liquid is applied on the surface of the conductive elastic roller A by dip coating and then dried by heating at 140° C. for 30 minutes to form a crosslinked structure. Thus, an outermost surface layer having a thickness of 10 μm is formed and a charging roller 1 is obtained.

The surface roughness Rz of the obtained charging roller 1 is 9 μm.

### (Preparation of Charging Roller 2)

A charging roller 2 is prepared by the same method as that of the charging roller 1, except that 33 parts by mass of polyamide resin particles 2 (2002DNAT1 available from Arkema, porous filler) are used instead of the polyamide resin particles 1.

The surface roughness Rz of the obtained charging roller 2 is 17 μm.

### (Preparation of Charging Roller 3)

A charging roller 3 is prepared by the same method as that of the charging roller 1, except that 6 parts by mass of polyamide resin particles 1 and 6 parts by mass of acid catalyst are used.

The surface roughness Rz of the obtained charging roller 3 is 3 μm.

### (Preparation of Charging Roller 4)

A charging roller 4 is prepared by the same method as that of the charging roller 1, except that the polyamide resin particles 1 are not added.

The surface roughness Rz of the obtained charging roller 4 is 1 μm.

### (Preparation of Charging Roller 5)

A charging roller 5 is prepared by the same method as that of the charging roller 1, except that 75 parts by mass of polyamide resin particles 2 (2002DNAT1 available from Arkema, porous filler) are used instead of the polyamide resin particles 1.

The surface roughness Rz of the obtained charging roller 5 is 22 μm.

### (Preparation of Charging Roller 6)

A charging roller 6 is prepared by the same method as that of the charging roller 1, except that nonporous polystyrene resin particles (SBX-6 available from SEKISUI PLASTICS Co., Ltd., nonporous filler) are used instead of the polyamide resin particles 1.

The surface roughness Rz of the obtained charging roller 6 is 10 μm.

Table 2 lists the surface roughness of each of the charging rollers.

TABLE 2

| Charging roller | Surface roughness (μm) | Remarks |
|---|---|---|
| Charging roller 1 | 9 | Example |
| Charging roller 2 | 17 | Example |
| Charging roller 3 | 3 | Example |
| Charging roller 4 | 1 | Comparative Example |
| Charging roller 5 | 22 | Comparative Example |
| Charging roller 6 | 10 | Comparative Example |

### Examples 1 to 15

The evaluation tests below are performed based on the combinations of photoconductors and charging rollers shown in Table 3.

### Comparative Examples 1 to 11

The evaluation tests below are performed based on the combinations of photoconductors and charging rollers shown in Table 3.

### [Evaluation Test 1]

The photoconductor and charging roller combined as shown in Examples and Comparative Examples are installed in a process cartridge of DocuCentre-IV C5570 manufactured by Fuji Xerox Co., Ltd. to perform an evaluation test for photoconductor abrasion.

In this evaluation test, 50000 A4 sheets each including, in a mixed manner, a belt-shaped image pattern (image portion) that has an average image density of 100% and extends in the circumferential direction of a photoconductor and a blank portion (no-image portion) that has an average image density of 0% are continuously printed in an environment of 25° C. and 85% RH. The evaluation is performed in accordance with the criteria below.

This evaluation test is performed at photoconductor charging potentials of −500 V and −800 V.

### —Evaluation of Photoconductor Abrasion—

G1: The average abrasion loss of the image portion and no-image portion is 1.0 μm or less.
G2: The average abrasion loss of the image portion and no-image portion is more than 1.0 μm and 2.0 μm or less.
G3: The average abrasion loss of the image portion and no-image portion is more than 2.0 μm and 3.0 μm or less.
G4: The average abrasion loss of the image portion and no-image portion is more than 3.0 μm.

### [Evaluation Test 2]

After a printing test that is the same as the evaluation test 1 has been performed, a 50% halftone image is printed. The image quality in a region where the belt-shaped image pattern is printed that has an average image density of 100% and extends in the circumferential direction of a photoconductor is evaluated in accordance with the criteria below.

This evaluation test is also performed at photoconductor charging potentials of −500 V and −800 V.

### —Evaluation of Image Quality Durability—

G1: No image defects are observed.
G2: Streaked image defects in the circumferential direction of a photoconductor are somewhat observed, but are insignificant because the difference in image density from the background is small.
G3: Some streaked image defects (less than 5% of the area of the image portion) in the circumferential direction of a photoconductor are observed.
G4: Streaked image defects (5% or more of the area of the image portion) in the circumferential direction of a photoconductor are observed.

Table 3 lists the results of the evaluation tests 1 and 2.

TABLE 3

| | | | Photoconductor abrasion | | Image quality durability | |
|---|---|---|---|---|---|---|
| | | | Charging potential | Charging potential | Charging potential | Charging potential |
| | Photoconductor | Charging roller | −500 V | −800 V | −500 V | −800 V |
| Ex. 1 | Photoconductor 1 | Charging roller 1 | G1 | G1 | G1 | G1 |
| Ex. 2 | Photoconductor 2 | Charging roller 1 | G2 | G2 | G1 | G2 |
| Ex. 3 | Photoconductor 3 | Charging roller 1 | G2 | G2 | G1 | G2 |
| Ex. 4 | Photoconductor 5 | Charging roller 1 | G1 | G1 | G1 | G1 |
| Ex. 5 | Photoconductor 7 | Charging roller 1 | G3 | G3 | G1 | G1 |
| Ex. 6 | Photoconductor 1 | Charging roller 2 | G1 | G1 | G1 | G1 |
| Ex. 7 | Photoconductor 2 | Charging roller 2 | G2 | G2 | G2 | G2 |
| Ex. 8 | Photoconductor 3 | Charging roller 2 | G2 | G2 | G2 | G3 |
| Ex. 9 | Photoconductor 5 | Charging roller 2 | G1 | G1 | G1 | G1 |
| Ex. 10 | Photoconductor 7 | Charging roller 2 | G3 | G3 | G1 | G1 |
| Ex. 11 | Photoconductor 1 | Charging roller 3 | G1 | G1 | G1 | G1 |
| Ex. 12 | Photoconductor 2 | Charging roller 3 | G2 | G2 | G2 | G2 |
| Ex. 13 | Photoconductor 3 | Charging roller 3 | G2 | G2 | G2 | G2 |
| Ex. 14 | Photoconductor 5 | Charging roller 3 | G1 | G1 | G1 | G1 |
| Ex. 15 | Photoconductor 7 | Charging roller 3 | G3 | G3 | G1 | G1 |
| C.E. 1 | Photoconductor 1 | Charging roller 4 | G2 | G2 | G4 | G4 |
| C.E. 2 | Photoconductor 3 | Charging roller 4 | G3 | G3 | G4 | G4 |
| C.E. 3 | Photoconductor 5 | Charging roller 4 | G2 | G2 | G4 | G4 |
| C.E. 4 | Photoconductor 7 | Charging roller 4 | G4 | G4 | G4 | G4 |
| C.E. 5 | Photoconductor 1 | Charging roller 5 | G3 | G3 | G3 | G3 |
| C.E. 6 | Photoconductor 3 | Charging roller 5 | G3 | G4 | G2 | G3 |
| C.E. 7 | Photoconductor 5 | Charging roller 5 | G3 | G3 | G3 | G3 |
| C.E. 8 | Photoconductor 7 | Charging roller 5 | G4 | G4 | G3 | G3 |
| C.E. 9 | Photoconductor 4 | Charging roller 2 | G4 | G4 | G3 | G3 |
| C.E. 10 | Photoconductor 6 | Charging roller 2 | G2 | G3 | G4 | G4 |
| C.E. 11 | Photoconductor 1 | Charging roller 6 | G2 | G2 | G3 | G4 |

Ex: Example
C.E.: Comparative Example

As is clear from the results above, the combinations in Examples are superior to those in Comparative Examples in terms of image quality durability. That is, the formation of streaked image defects in the circumferential direction of a photoconductor is suppressed.

It is also clear that the abrasion of photoconductors in Examples is further suppressed compared with that in Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an electrophotographic photoconductor that includes an outermost surface layer containing a binder resin having a structural unit represented by general formula (A) below and a charge transporting material having a butadiene trimer structure in a single molecule;
a charging unit that charges the electrophotographic photoconductor and includes an outermost surface layer containing a porous filler and having a surface roughness Rz of about 2 μm or more and about 20 μm or less;
an electrostatic latent image forming unit that forms an electrostatic latent image by exposing the charged electrophotographic photoconductor;
a toner image forming unit that forms a toner image by developing, with a developer containing a toner, the electrostatic latent image formed on the electrophotographic photoconductor; and
a transfer unit that transfers the toner image formed on the electrophotographic photoconductor onto a transfer-receiving body, 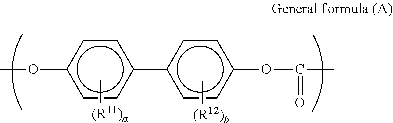
where R¹¹ and R¹² each independently represent a halogen atom, an alkyl group having 1 to 6 carbon atoms, a cycloalkyl group having 5 to 7 carbon atoms, or an aryl group having 6 to 12 carbon atoms; and a and b each independently represent an integer of 0 to 4.

2. The image forming apparatus according to claim 1, wherein the binder resin is a copolymer having the structural unit represented by the general formula (A) and a structural unit represented by general formula (B) below, 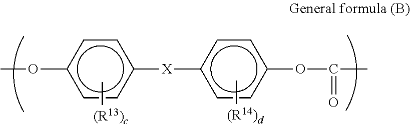
where R¹³ and R¹⁴ each independently represent a halogen atom, an alkyl group having 1 to 6 carbon atoms, a cycloalkyl group having 5 to 7 carbon atoms, or an aryl group having 6 to 12 carbon atoms; c and d each independently represent an integer of 0 to 4; and X represents —CR¹⁵R¹⁶— (R¹⁵ and R¹⁶ each independently represent a hydrogen atom, a trifluoromethyl group, an alkyl group having 1 to 6 carbon atoms, or an aryl group having 6 to 12 carbon atoms), a 1,1-cycloalkylene group having 5 to 11 carbon atoms, an α,ω-alkylene group having 2 to 10 carbon atoms, —O—, —S—, —SO—, or —SO₂—.

3. The image forming apparatus according to claim 2, wherein the copolymerization ratio of the structural unit represented by the general formula (A) to all structural units constituting the binder resin is about 15% or more and about 25% or less by mole.

4. The image forming apparatus according to claim 1, wherein the outermost surface layer of the electrophotographic photoconductor contains fluorocarbon resin particles.

5. The image forming apparatus according to claim 2, wherein the outermost surface layer of the electrophotographic photoconductor contains fluorocarbon resin particles.

6. The image forming apparatus according to claim 1, wherein the charge transporting material having a butadiene trimer structure in a single molecule is a charge transporting material represented by general formula (1) below, 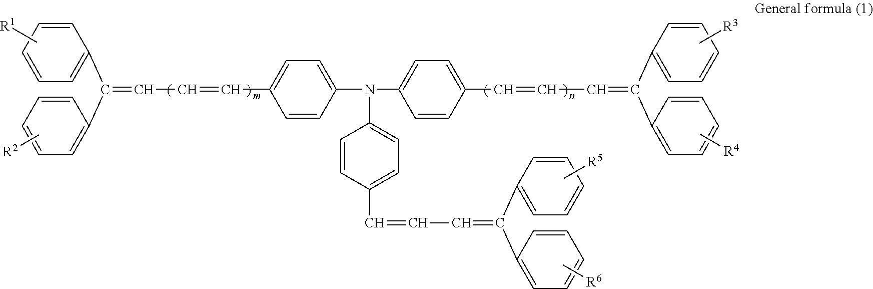
where R¹, R², R³, R⁴, R⁵, and R⁶ each independently represent a hydrogen atom, a halogen atom, an alkyl group having 1 to 20 carbon atoms, an alkoxy group having 1 to 20 carbon atoms, or a substituted or unsubstituted aryl group having 6 to 30 carbon atoms; two adjacent substituents may be bonded to each other to form a hydrocarbon ring structure; and n and m each independently represent 1 or 2.

7. The image forming apparatus according to claim 1, wherein the content of the charge transporting material having a butadiene trimer structure in a single molecule is about 5% or more and about 45% or less by mass relative to the total solid content of the outermost surface layer.

8. The image forming apparatus according to claim 1, wherein the content of the binder resin is about 30% or more and about 90% or less by mass relative to the total solid content of the outermost surface layer.

9. The image forming apparatus according to claim 4, wherein the fluorocarbon resin particles have an average primary particle size of about 0.05 μm or more and about 1 μm or less.

10. The image forming apparatus according to claim 4, wherein the content of the fluorocarbon resin particles is about 2% or more and about 15% or less by mass relative to the total solid content of the outermost surface layer.

11. A process cartridge detachably mounted in an image forming apparatus, comprising:
an electrophotographic photoconductor that includes an outermost surface layer containing a binder resin having a structural unit represented by general formula (C) below and a charge transporting material having a butadiene trimer structure in a single molecule; and
a charging unit that charges the electrophotographic photoconductor and includes an outermost surface layer containing a porous filler and having a surface roughness Rz of about 2 μm or more and about 20 μm or less, 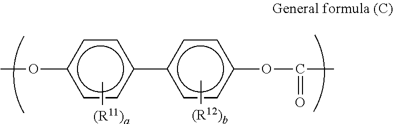
where R¹¹ and R¹² each independently represent a halogen atom, an alkyl group having 1 to 6 carbon atoms, a cycloalkyl group having 5 to 7 carbon atoms, or an aryl group having 6 to 12 carbon atoms; and a and b each independently represent an integer of 0 to 4.

12. The process cartridge according to claim 11, wherein the binder resin is a copolymer having the structural unit represented by the general formula (C) and a structural unit represented by general formula (D) below, 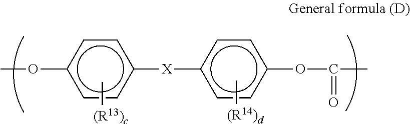
where R¹³ and R¹⁴ each independently represent a halogen atom, an alkyl group having 1 to 6 carbon atoms, a cycloalkyl group having 5 to 7 carbon atoms, or an aryl group having 6 to 12 carbon atoms; c and d each independently represent an integer of 0 to 4; and X represents —CR¹⁵R¹⁶— (R¹⁵ and R¹⁶ each independently represent a hydrogen atom, a trifluoromethyl group, an alkyl group having 1 to 6 carbon atoms, or an aryl group having 6 to 12 carbon atoms), a 1,1-cycloalkylene group having 5 to 11 carbon atoms, an α,ω-alkylene group having 2 to 10 carbon atoms, —O—, —S—, —SO—, or —SO₂—.

13. The process cartridge according to claim 12, wherein the copolymerization ratio of the structural unit represented by the general formula (C) to all structural units constituting the binder resin is about 15% or more and about 25% or less by mole.

14. The process cartridge according to claim 11, wherein the outermost surface layer of the electrophotographic photoconductor contains fluorocarbon resin particles.

15. The process cartridge according to claim 11, wherein the charge transporting material having a butadiene trimer structure in a single molecule is a charge transporting material represented by general formula (2) below, 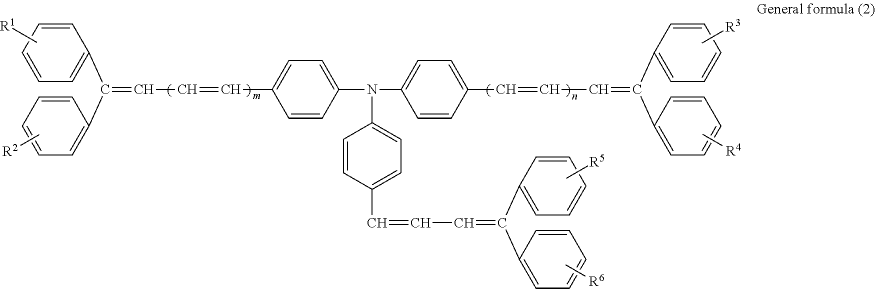
where R¹, R², R³, R⁴, R⁵, and R⁶ each independently represent a hydrogen atom, a halogen atom, an alkyl group having 1 to 20 carbon atoms, an alkoxy group having 1 to 20 carbon atoms, or a substituted or unsubstituted aryl group having 6 to 30 carbon atoms; two adjacent substituents may be bonded to each other to form a hydrocarbon ring structure; and n and m each independently represent 1 or 2.

16. The process cartridge according to claim 14, wherein the fluorocarbon resin particles have an average primary particle size of about 0.05 μm or more and about 1 μm or less.

17. The process cartridge according to claim 14, wherein the content of the fluorocarbon resin particles is about 2% or more and about 15% or less by mass relative to the total solid content of the outermost surface layer. epoxycyclohexyl)ethyltrimethoxysilane,
